(19) United States
(12) Patent Application Publication
(10) Pub. No.: US 2026/0359597 A1
(43) Pub. Date: Nov. 12, 2026

(54) DEVICES AND METHODS FOR PERFORMING COLLECTIVE OPERATIONS USING ELECTROMAGNETIC SIGNALS

(71) Applicant: Microsoft Technology Licensing, LLC, Redmond, WA (US)

(72) Inventor: Teresa A. NICK, Towson, MD (US)

(73) Assignee: Microsoft Technology Licensing, LLC, Redmond, WA (US)

(21) Appl. No.: 19/203,013

(22) Filed: May 8, 2025

(51) Int. Cl. G06N 3/04

(52) U.S. Cl. CPC G06N 3/04

(57) ABSTRACT

A device for performing collective operations using electromagnetic energy includes an input layer and a static layer. The input layer includes at least one emitter for displaying electromagnetic signals encoded via an intensity of electromagnetic energy. The at least one emitter is configured to emit electromagnetic energy at a low intensity, and to emit electromagnetic energy at a high intensity that is greater than the low intensity. The static layer includes a substrate having at least one optical passage therethrough corresponding with the at least one emitter. The input layer and the static layer are optically coupled such that the at least one emitter emits electromagnetic energy into the at least one optical passage. The optical passage includes at least one optical filter, and the static layer is encoded via an opacity of the at least one optical filter.

Artificial intelligence (AI) is used to perform complex tasks such as reading comprehension, language translation, image recognition, or speech recognition. Artificial intelligence systems, such as those based on Natural Language Processing (NLP), Recurrent Neural Networks (RNNs), Convolutional Neural Networks (CNNs), Long Short-Term Memory (LSTM) neural networks, or Gated Recurrent Units (GRUs) have been deployed to perform such complex tasks. In many such systems, parallelism is used to accelerate operations associated with the model. Parallel operations and the multiplication of matrices are utilized for processing information (e.g., inputs or embeddings) though the various layers of the model, and loading memory to perform these operations can present significant bottlenecks, which ultimately degrades performances of artificial intelligence systems during both inference and training.

Accordingly, there is a need for systems and methods that reduce latencies in artificial intelligence models.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates an example of performing a multiplication computation by displaying electromagnetic signals, according to at least one embodiment of the present disclosure;

FIG. 2 illustrates an encoding scheme which may be used for encoding, displaying, and summing values via electromagnetic signals as part of a collective operation, according to at least one embodiment of the present disclosure;

FIG. 3-1 illustrates an example operation in which data is computed at a layer L−1 and communicated to a layer L, according to at least one embodiment of the present disclosure;

FIG. 3-2 illustrates an example operation in which data is computed at the layer L−1 and communicated to the layer L, according to at least one embodiment of the present disclosure.

FIG. 4-1 illustrates an example of a device for performing collective operations as described herein, according to at least one embodiment of the present disclosure;

FIG. 4-2 illustrates an example of a device for performing collective operations as described herein, according to at least one embodiment of the present disclosure;

FIG. 5-1 illustrates an example of various nodes of a layer L−1 and various nodes of a layer L, and connections therebetween, according to at least one embodiment of the present disclosure.

FIG. 5-2 illustrates an operation in which weighted activations are computed at the layer L−1 and transmitted to the layer L, according to at least one embodiment of the present disclosure;

FIG. 5-3 illustrates an example of performing multiplication based on the summation of electromagnetic properties, according to at least one embodiment of the present disclosure;

FIG. 6 illustrates a flow diagram for a method or a series of acts for performing optical multiplication, according to at least one embodiment of the present disclosure; and

FIG. 7 illustrates certain components that may be included within a computer system, according to at least one embodiment of the present disclosure.

### DETAILED DESCRIPTION

Typically, AI systems include various layers, sublayers, or even smaller portions of the artificial AI model that are partitioned to achieve model parallelism. A s an example, in parallelism, different processing units in the system may be responsible for the computations in different parts of a single network. For example, each layer, sublayer, or even a smaller portion of the neural network may be assigned to a different processing unit in the system. Thus, as part of parallelism, the neural network model may be split among different processing units (e.g., C PUs, G PUs, IPUs, FPGA s, or other types of such units). Various nodes or neurons make up each layer and are interconnected to form the neural network. As used herein the term “node” or “neuron” refers to a connection point in an AI system having layers for processing inputs and providing outputs, where the connection point has the capability to receive an input and provide an output to other connection points (nodes) in the AI system.

In some embodiments, each processing unit may receive data from a previous processing unit (e.g., a previous layer) and may perform computations on the data for transmitting to a next processing unit (e.g., a next layer). The computations often involve multiplication of a set of input values and associated set of learned parameters. For example, in feed forward neural networks, activation values and an associated set of weight values are used to generate a set of weighted activation values for the various nodes in the layer. The set of weighted activation values may be summed and/or passed on to the nodes of a next layer, where weights of that layer are multiplied thereto to generate weighted activations for that layer, and so on for various, and often many, layers of the model. Each layer typically includes many nodes which are implemented, hosted, or operated by one or more processing units, often graphical processing units (GPUs). Thus, the set of activations and the set of weights for the various nodes in a layer are generally represented via matrices, and the processing unit performs element-wise multiplication thereof to generate the weighted activations. Other portions or operations of AI models may also involve the multiplication of values (e.g., matrices of many values), both during training or learning, as well as during inference. For instance, query weight matrices, key weight matrices, and/or value weight matrices may be utilized for multiplication computations in connection with input embeddings, for example, as part of a self-attention operation or feature of a model. Thus, the operation of AI models may rely heavily on multiplication computations.

Multiplication in this way for AI models is very memory and computation expensive. For example, it is not uncommon for modern AI models to have trillions of parameters (e.g., nodes), resulting in billions of memory loads and computations (e.g., multiplications) to perform at each layer. Indeed, weight matrices representing learned information at one or more layers are typically quite large, such as up to millions or even billions of weights for each layer. While GPUs are leveraged for their ability to perform large amounts of parallel operations efficiently, the sheer volume of data that needs to be loaded into memory to perform the computations (e.g., multiplications) can present a considerable bottleneck to the operation of an AI model.

Even given that GPUs may be particularly suited for performing a large number of computations, fetching and storing data from memory can nevertheless introduce significant latency issues. For instance, moving data between GPUs (or other processing units) and VRAM (or other memory) is often orders of magnitude slower than the computations themselves. Indeed, a considerable amount of the bottleneck/latency issues with AI models is often attributable to the delay in memory access functions. Moreover, AI models require a significant amount of memory resources to store matrices and other data. As memory hardware resources are finite (e.g., and limited), and the volume of data utilized by AI models is continually growing, data overflows spill to slower memory or storage devices, causing further delays.

The present disclosure provides advantageous improvements to these, and other issues associated with performing multiplication operations in artificial intelligence (AI) models by using a property of electromagnetic energy, such as an intensity of light or optical signals, to encode input values as a pattern of various entries. By filtering the electromagnetic signals through various filters of a static layer, which filters exhibit selected opacity to encode a static or learned parameter, the resulting cumulative electromagnetic signals viewed through the static layer can be leveraged to effectively multiply the input values and learned parameters. This technique can be utilized for performing the element-wise multiplication of matrices containing multiple values, based on displaying several electromagnetic signals, emitting them through the static layer, and detecting or observing the resulting cumulative electromagnetic signals. For instance, a property (e.g., light intensity or brightness) of the electromagnetic signals may be filtered to varying degrees to produce a resulting property (e.g., light intensity or brightness), which property may be relied on to infer a sum of the underlying values. In some cases, multiplication can be performed based on addition or summation in this way, for example, based on the relationship between the addition and multiplication of logarithms.

In this way, a set of activations in an activation matrix may be multiplied by a set of weights values in a weight matrix (e.g., or other multiplication computations of an AI model) for producing weighted activations for the various nodes in a model layer, for example, without relying on a processing unit to perform the actual multiplication computations. Thus, by performing multiplication based on the selective filtering of electromagnetic signal intensity as described herein, memory intensive multiplication operations may be performed with two distinct parallel inputs, providing valuable efficiency gains when considered in the aggregate across the AI model as a whole. For instance, a physical, static, substrate component can be encoded to represent large, learned matrices (e.g., for inference) such that voluminous weight matrices do not have to be recalled from memory and do not even require any electrical operations specifically for the weight matrices to be utilized for multiplication operations. Indeed, in some cases, the need for sophisticated and robust GPU's may be eliminated altogether, and the multiplication operations may be achieved based on utilizing only FPGAs, other more efficient processors, or even more basic processing components. By not relying on a processing unit to perform brute force multiplication of numerous input values and learned parameters, computations, including the numerous data transfers between the processing unit and memory to perform the multiplication computations (e.g., storing and/or fetching activation values and/or weight values, intermediate memory usage as part of the multiplication computation, etc.), latency may be significantly reduced, which may further streamline the neural network processing of data at a given model layer and the communication thereof between layers, as well as accelerating self-attention.

As used herein, an “AI model,” may be inclusive of machine learning and other techniques that refer to a computer model or computer representation that may be trained (e.g., optimized) based on inputs to approximate unknown functions. For instance, an AI model may include, but is not limited to, a neural network (e.g., a convolutional neural network (CN N) or deep learning model), a decision tree (e.g., a gradient-boosted decision tree), a linear regression model, a logistic regression model, or a combination of these models.

As another example, AI models may include computer models comprising interconnected artificial neurons that communicate and learn to approximate complex functions, generating outputs based on multiple inputs provided to the model. For instance, an AI model may include an algorithm (or set of algorithms) that employs deep learning techniques and uses training data to adjust the parameters of the network and model high-level abstractions in data. Various types of AI models exist, such as neural networks, including convolutional neural networks (CNNs), residual learning neural networks, recurrent neural networks (RNNs), generative neural networks, generative adversarial neural networks (GA N s), and single-shot detection (SSD) networks. In one or more examples herein, an AI model may be implemented as an autoencoder model, such as a model which learns an encoding function that transforms input data and a decoding function that recreates the input data from the encoded representation.

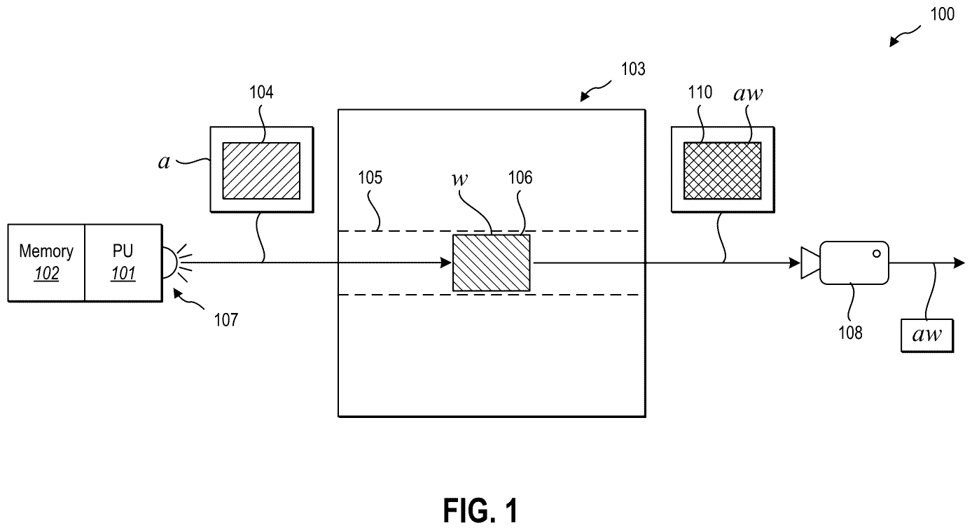

FIG. 1 illustrates an example of a performing a multiplication computation by displaying electromagnetic signals, according to at least one embodiment of the present disclosure. For instance, the multiplication computation may be a multiplication performed as part of operation of an AI or machine learning (ML) model.

A processing unit (PU) 101 may include or be associated with a memory 102. The PU may be any type of processing unit, hardware, or component, such as a computer processing unit (CPU), graphics processing unit (GPU), tensor processing unit (TPU), AI accelerator, processing core, logic component, or other. In at least one embodiment, the PU 101 is not a GPU. The memory 102 may be any of a variety of types of memory such as random access memory (RAM), dynamic random access memory (DRAM), High Bandwidth Memory (HBM), or any other memory as described herein.

In some cases, the PU 101 implements, hosts, operates, or is otherwise associated with a layer of an AI model. For example, the PU 101 may implement various nodes comprising the layer. For this example, the PU 101 may be shown and described with respect to a single node and/or a single connection to another node and/or PU of another layer. For example, the PU 101 may receive or determine a (e.g., single) activation a which may be a value corresponding to the node. In some cases, the activation ais based on activations received from a previous layer and/or node, such as based on an activation function of weighted activations from various nodes and an associated bias. As used herein, an “activation,” “activation value,” or the like may refer to any input value which is received, determined, or which applies specifically to a node of an AI model. For example, an activation may be any value (e.g., number) which is generated and/or received by any portion of an AI model, and may not be limited to only being activation values, for instance, as part of an inferencing operation of an AI model.

In some cases, AI models as described herein are implemented by many processing units for operating multiple layers, each having one or more nodes. Each processing unit may be configured to process one or more neurons associated with a layer. As an example, assuming there are 256 neurons in layer L, a first processing unit may be configured to process a subset of the 256 neurons, a second processing unit may be configured to process a next subset of the 256 neurons, a third processing unit may be configured to process a further subset of the 256 neurons, and so forth. Partitioning may be performed using code configured to partition the model based on machine language frameworks, such as Tensorflow, A pache M×Net, and Microsoft® Cognitive Toolkit (CNTK). Thus, the various layers of the model may be assigned for processing using different processing units. This way the various parameters associated with layers may be processed in parallel. In some cases, two or more processors may be associated with a same layer of a model. For example, as described herein, one processor may be associated with generating, displaying, and/or emitting electromagnetic signals for activation values and another processor (or other non-processing electronic device) may be associated with detecting cumulative electromagnetic signals through a static layer representing weighted activation values as described herein.

In one example, a neural network model may comprise of many layers and each layer may be encoded as matrices or vectors of weights expressed in the form of coefficients or constants that have been obtained via training of a neural network. Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a single chunk of content may be encoded into a single vector or multiple vectors. As an example, a word or a combination of words (e.g., a phrase, a sentence, or a paragraph) may be encoded as a single vector. Each chunk may be encoded into an individual layer (e.g., a particular time step) of an LSTM network. An LSTM layer may be described using a set of equations, such as the ones below:

iₜ=σ(Wₓᵢxt+Wₕᵢhₜ₋₁+W_{ci}c_{t_1}+bᵢ)

fₜ=σ(W_{xf}xₜ+W_{hf}hₜ₋₁+W_{cf}cₜ₋₁+b_{f})

cₜ=fₜcₜ₋₁iₜ tan h(W_{xc}xₜ+W_{hc}hₜ₋₁+b_{c})

oₜ=σ(Wₓₒxₜ+Wₕₒhₜ₋₁+W_{co}cₜ+bₒ)

hₜ=oₜ tan h(cₜ)

In this example, inside each LSTM layer the inputs and hidden states may be processed using a combination of vector operations (e.g., dot-product, inner product, or vector addition) and non-linear functions. In certain cases, the most compute intensive operations may arise from the dot products, which may be implemented using dense matrix-vector and matrix-matrix multiplication routines.

Although transmission bandwidth as described herein may be limited by visible light peripherals, such as displays, emitters, and image sensors operating based on visible light, that are optimized for relatively slow human vision, this limit does not present a technological barrier. For example, in some embodiments, peripherals for generating electromagnetic signals (e.g., projectors, displays, etc.) and for receiving or sensing electromagnetic energy signals (e.g., image sensors or light sensors) may be implemented which may operate based on electromagnetic energy that is not in the visible spectrum and/or optimized for speeds above that which human vision can detect. For instance, electromagnetic energy from at least infrared rays to ultraviolet rays, including visible light, may be used with the systems and methods described herein. In terms of wavelength, the electromagnetic energy may range from nanometers (e.g., 400 nanometers) to a few microns (e.g., 1.6 microns). The specific range of wavelength that is used will depend on the type of displays, sensors, or other such equipment being used for the communication of the electromagnetic energy. As an example, radiofrequency waves in a range of 3 kHz to 300 MHz may be used. A s another example, microwaves in a range of 300 MHz to 300 GHz may also be used. Depending on the frequency, and thus the wavelength, of the electromagnetic energy being used, the equipment used for communicating such signals may be tailored.

A s described herein, the activation amay be associated with a corresponding weight w which may be a weight value representative of learned or trained information of an AI model for the node and activation a. For instance, a product of the activation a and the weight wmay be a weighted activation “aw,” which may be passed on to a further layer and/or node(s). The PU 101 may store the activation a in the memory 102. It should be understood that the techniques shown and described in connection with FIG. 1 may be applicable to operating (e.g., performing multiplications for) multiple nodes of a layer simultaneously. As used herein, “weight,” “weight value,” or the like may refer to any learned parameter by an AI model. For example, a weight may be any parameter (e.g., number) which is static, known, or learned and which corresponds with an input value for adjusting, modifying, or otherwise weighting the input value.

A product value (or a set of product values) representing a product of the weight wand the activation a (e.g., the weighted activation av) may be achieved based on displaying electromagnetic signals at a display 107 and the displayed electromagnetic signals being emitted through a static layer 103. The static layer 103 can include an optical passage 105 having an optical filter 106 positioned therein. More information regarding the display and emission of electromagnetic signals and the static layer is described in connection with FIGS. 4-1 and 4-2.

In some embodiments, the optical filter 106 exhibits an electromagnetic property (e.g., opacity) that may filter or act on the intensity or brightness of the electromagnetic energy, such as shading or otherwise reducing the intensity. The optical filters 106 may be implemented to encode the weight win the static layer 103 as described in connection with one or more embodiments herein. In this way, the static layer 103 may represent a non-computing device and/or a non-electronic device in which the weight w (e.g., or a representation thereof) may be hard-coded or hard-formed, and which may facilitate adjusting, modifying, or otherwise changing the electromagnetic signal 104 in order to perform a collective operation. In contrast, the activation a, in some cases, may be dynamic and/or changing, and the PU 101 may receive the activation a, may generate the activation a, and/or may perform one or more computations on the activation a, etc.

Based on emitting the electromagnetic signal 104 through the static layer, a cumulative electromagnetic signal 110 may be generated. For example, the cumulative electromagnetic signal 110 may be representative of a cumulative nature of the electromagnetic properties of the electromagnetic signal 104 and of the optical filter 106. For example, the cumulative electromagnetic signal 110 may be a combination, aggregation, and/or sum of the intensity of the electromagnetic signal 104 and a filtering effect or opacity of the optical filter 106. For instance, in some cases the optical filter 106 may reduce the intensity of the electromagnetic signal 104 such that the cumulative electromagnetic signal 110 exhibits a reduced intensity. In some cases, the optical filter 106 may not reduce the intensity of the electromagnetic signal 104 such that the cumulative electromagnetic signal 110 exhibits a same or similar intensity to that of the electromagnetic signal 104. Thus, the intensity of the cumulative electromagnetic signal 110 may represent a sum of the electromagnetic property (e.g., intensity) of the electromagnetic signal 104 and the electromagnetic property (e.g., opacity) of the optical filter 106. For instance, the summation of these electromagnetic properties may occur naturally and/or inherently, without a device or processor having specifically performed a summation computation.

An image sensor 108 may detect, measure, or observe the cumulative electromagnetic signal 110 emitted through the static layer 103. Based on the image sensor 108 observing the cumulative electromagnetic signal 110, the combined or summed properties of the electromagnetic signal 104 and the optical filter 106 exhibited by the cumulative electromagnetic signal 110 may be determined. For example, the light intensity of the cumulative electromagnetic signal 110 may represent a combined or cumulative light intensity of the electromagnetic signal 104 as acted on or modified by the optical filter 106. In other examples, other combined properties may be observed. More details related to image sensors are described herein in connection with FIGS. 4-1 and 4-2.

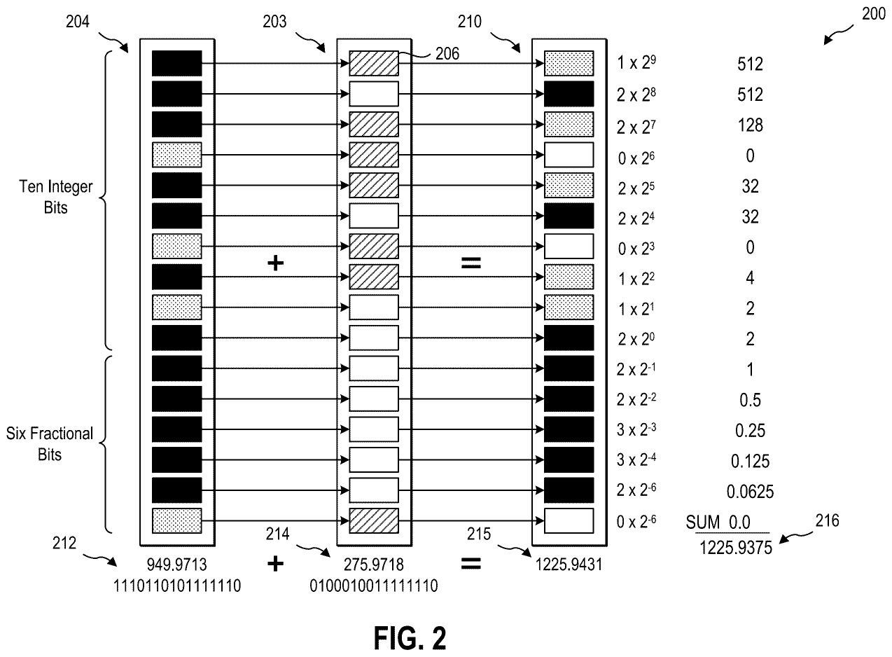

The light intensity of the various electromagnetic signals described herein may be leveraged to encode information. For example, the light intensity may be selected to encode a bit value or entry into a pattern displayed via an electromagnetic signal. While the electromagnetic signal 104, the optical filter 106, and the cumulative electromagnetic signal 110 are shown as a single entry, such as a single pixel, bit, or region, this is for simplicity and illustrative purposes. Indeed, the electromagnetic signals herein may each comprise a pattern of several entries for encoding information (e.g., the activation a) via any number of entries. For instance, in at least one embodiment, the electromagnetic signals herein are each a pattern of 16 entries which, through selectively displaying a light intensity a teach entry, may convey an underlying decimal value (e.g., activation a, weighted activation aw, etc.). More details regarding encoding schemes for electromagnetic signals and for the static layer are described below in connection with FIG. 2. By emitting the entries of the electromagnetic signal 104 through corresponding optical filters 106 in the static layer 103, properties of the entries and the optical filters 106 may naturally and/or inherently sum, interact, and/or add, which may represent a sum of the underlying decimal values of the activation a and the weight w (or more specifically a sum of logarithmic representations of these values). Accordingly, the cumulative electromagnetic signal 110 may be observed by the image sensor 108 to infer the sum of the underlying activation and weight values.

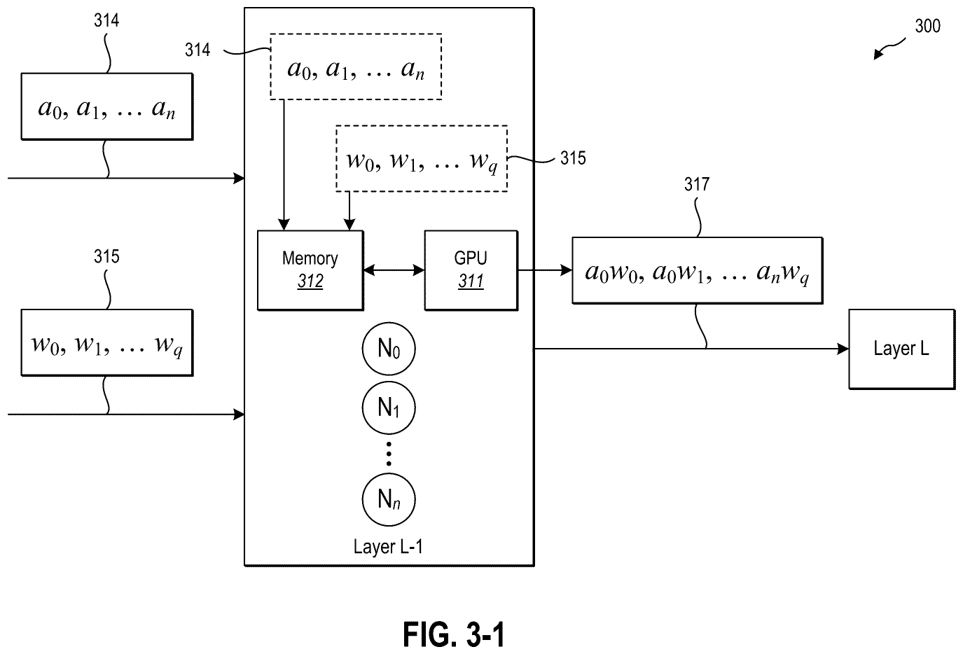

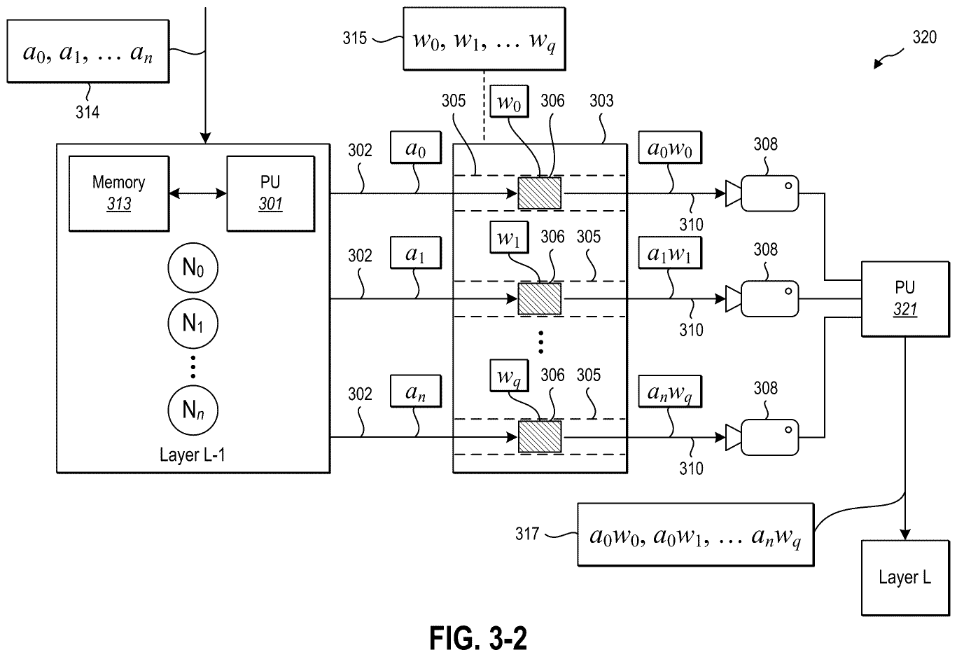

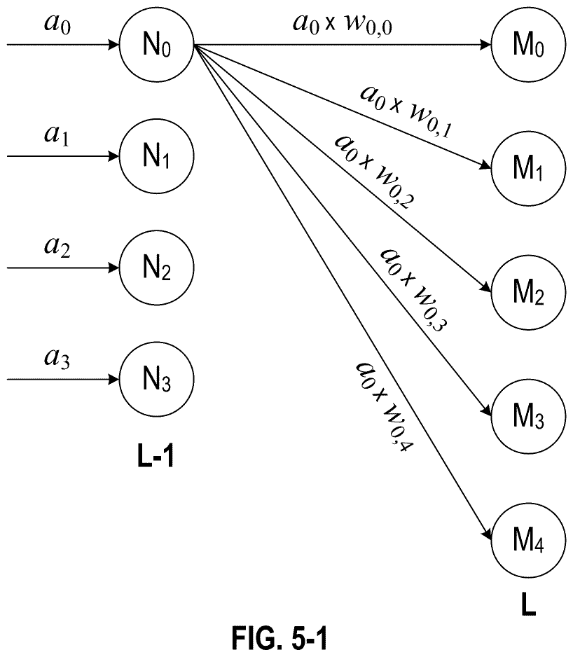

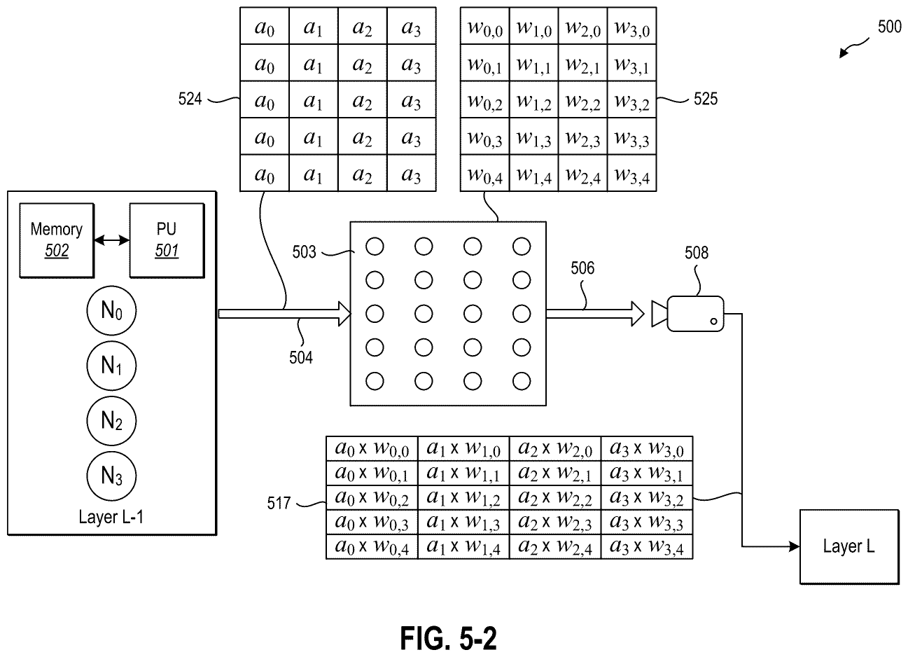

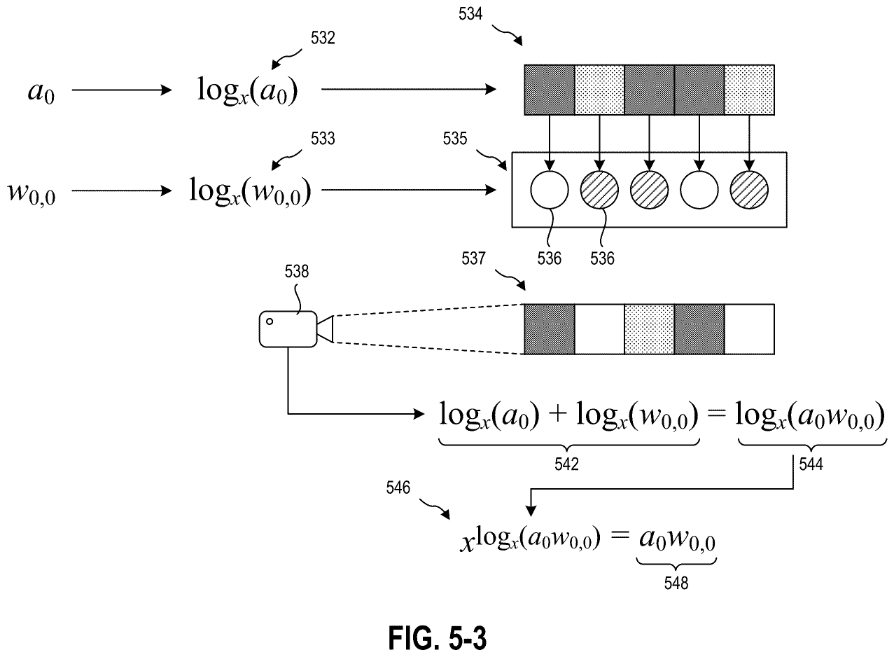

In some cases, this technique of summing values via cumulative electromagnetic signals may be leveraged to perform multiplication operations. For example, the product rule of logarithms states that log(xy)=log(x)+log(y). Thus, by leveraging the relationship between addition (e.g., summation) and multiplication of logarithms, the electromagnetic properties of electromagnetic signals and of the static layer(s) may be summed to convey a product. For example, in some cases, the electromagnetic signal 104 is an encoding of a transformation of the value of the activation a to a logarithmic value. Similarly, the static layer 103 may encode, via the optical filters 106, a transformation of the value of the weight w to a logarithmic value. The sum of these logarithmic values as conveyed via the cumulative electromagnetic signal 110 may be reverse transformed, or exponentiated, to produce the product of the weight wand the activation a. More details related to the logarithmic transformations and multiplication based on summing electromagnetic properties are described below in connection with FIG. 5-3.

Accordingly, based on displaying multiple electromagnetic signals and emitting the signals through a static layer, one or more properties of the electromagnetic signals may naturally combine and/or sum with properties of the static layer, which may be leveraged to perform multiplication computations, for example, without a processor or other device actively performing the multiplication computation. As described herein, this technique may be leveraged in AI model implementations to decrease latency and bottlenecks associated with multiplication. Indeed, electromagnetic signals representing multiple (e.g., a matrix of) activation values may be emitted through a static layer representing multiple (e.g., a matrix of) associated weight values such that large-scale multiplication may be performed through the natural summation of electromagnetic properties without relying on processing components to perform the computations.

FIG. 2 shows an encoding scheme 200 which may be used for encoding, displaying, and summing values via electromagnetic signals as part of a collective operation, according to at least one embodiment of the present disclosure. In this example, the encoding scheme 200 includes an encoding for an input layer including an electromagnetic signal 204, via electromagnetic intensity of the electromagnetic signal 204; an encoding for a static layer 203 via opacity of optical filters; and an encoding (e.g., or decoding) for a detection layer including a resulting cumulative electromagnetic signal 210, based on various discrete electromagnetic intensities.

In some cases, electromagnetic signals may be represented as a pattern of entries, such as regions, pixels, or other bit-identifying areas, having varying light intensity for conveying bit values for a series of bits in a fixed-point binary representation for an underlying decimal value. Although floating point representation of values as part of the model processing may have slightly higher accuracy, this comes at the expense of transmission bandwidth. Accuracy and bandwidth can be optimized for each use case. To simplify the processing while maintaining a reasonable dynamic range of the values, fixed point representation of values may be used. In one example, fixed point representation may use a set number of integer bits and fractional bits to express numbers. Fixed point values can be efficiently processed in hardware with integer arithmetic, which may make it a preferred format for use with the systems described herein. Fixed point format may be represented as X. Y, where X is the number of integer bits and Y is the number of fractional bits. For example, two's complement encoding may enable signed (+/−) values. Block-floating point (BFP) may apply a shared exponent to a block of fixed-point numbers; for example, a vector or matrix. The shared exponent may allow a significantly higher dynamic range for the block, although individual block members have a fixed range with respect to each other. Quantization involving mapping continuous or high-precision values onto a discrete, low-precision grid, may be used to arrive at the fixed-point representations of the floating-point values. If the original points are close to their mapped quantization value, then one expects that the resulting computations will be close to the original computations.

As part of the encoding scheme 200, the electromagnetic signal 204, the static layer 203, and the cumulative electromagnetic signal 210 may each be encoded using fixed-point integer values. For instance, in the example shown in FIG. 2, the fixed-point integer values include ten integer bits and six fractional bits, but other quantities of integer and fractional bits may be used. The electromagnetic signal 204 may be encoded based on a first value 212. In order to perform multiplication of an activation value based on summation, the first value 212 may be a logarithmic transformation of an activation value for a connection between a first node and a target node. The static layer 203 may be encoded based on a second value 214 and based on selecting the opacity of various optical filters 206 as a pattern of various entries. In order to perform multiplication of an activation and a weight value based on summation, the second value 214 may be a logarithmic transformation of a weight value for a same connection between the first node and the target node. The cumulative electromagnetic signal 210 may represent a sum value 216 which may be an estimate or approximation of the true sum 215 of the first value 212 and the second value 214 as described herein. For instance, by decoding the resulting intensities of the entries of the cumulative electromagnetic signal 210, the sum value 216 can be determined.

While the electromagnetic signal 204, static layer 203, and cumulative electromagnetic signal 210 are shown as columns, any shape, pattern, or form having various entries may be utilized for conveying the underlying values 212, 214, 216 based on specific indexed locations of the entries. For instance, FIG. 2 may be merely illustrative of the encoding scheme 200, and the various electromagnetic signals and/or static layer may not necessarily present or be displayed as shown. For instance, other shapes, configurations, or arrangements of entries may be utilized such as other arrangements of rows, columns, or another pattern, array, or form of various entries. Additionally, while each of the electromagnetic signal 204, static layer 203, cumulative electromagnetic signal 210 is shown as conveying or representing a single value, in some cases multiple values may be conveyed at each layer such that multiple values may be summed (e.g., multiplied as described herein) and decoded via the cumulative electromagnetic signal 210.

Accordingly, the relative positioning of the entries may correspond with various index positions of the associated encoding scheme. For instance, the encoding scheme may define a specific number of integer bits and fractional bits, and the index position may indicate which digit or position in the binary representation of the value each bit corresponds to (e.g., 10^{th} integer bit, 9^{th} integer bit, 1^{st} fractional bit, etc.). As shown adjacent the cumulative electromagnetic signal 210, the index position may be defined by and/or may correspond with a multiplication factor, which in some cases may be based on a binary order or scheme. For instance, the multiplication factor may be a binary exponential multiplication factor. As an example, the index position of the tenth integer bit may correspond to a multiplication factor of 2⁹, an index position of the 9^{th} integer bit may correspond to a multiplication factor of 2⁸, and so on.

In this way, the first value 212 may be represented in binary form by the electromagnetic signal 204. For example, at each entry of the electromagnetic signal 204, a light intensity may be selected to represent, in binary form, a 1 or a 0. For instance, the light intensity may be high or low, or other binary variation. In at least one embodiment, the entries of the electromagnetic signal 204 are represented by non-zero intensity values, such as a “0” value being communicated by a “low” emitted intensity, for example, rather than an “off” intensity. For instance, in the example shown in FIG. 2, the black entries of the electromagnetic signal 204 may correspond with electromagnetic energy emitted at a high intensity, and the grey entries of the electromagnetic signal 204 may correspond with electromagnetic energy emitted at a low intensity that is less than the high intensity but that is non-zero. In some cases, each entry is displayed and emitted by one (or multiple) emitters of a display device.

In a similar manner, the static layer 203 may be encoded to represent the second value 214. For example, as described herein the static layer 203 may comprise a substrate or material having various optical passages (not shown) therethrough. Within each optical passage, an optical filter 206 may be positioned which may have a selected opacity so as to encode the various entries of the encoding scheme and in this way represent the second value 214. In at least one embodiment, the optical filters 206 may be either a low filter (represented by optical filters 206 with cross-hatching), having a high opacity, or a high filter (represented by optical filters 206 with no cross-hatching), having a low opacity less than the high opacity. For instance, the low filter may result in less light (or less intensity) passing through the filter based on the high opacity, and may encode a 0 for a corresponding entry of the static layer 203. Further, the high filter may result in more light (or more intensity) passing through the high filter based on the low opacity, and may encode a 1 for a corresponding entry of the static layer 203.

In this way, the second value 214 may be encoded based on the optical filters 206 having a selected opacity for representing the various entries of the index positions. In some cases, the high filter may be transparent and/or may have no opacity such that the intensity of an associated entry is the same at the electromagnetic signal 204 as it is at the cumulative electromagnetic signal 210. For instance, a high filter may be implemented as an optical passage with no filter positioned therein. Accordingly, the optical filters 206, and more specifically the opacity, may represent the various entries of the associated index positions for encoding the underlying second value. More details regarding optical filters and the static layer are described herein in connection with FIGS. 4-1 and 4-2.

Based on emitting the electromagnetic signal 204 through the static layer 203, the cumulative electromagnetic signal 210 may be generated. For example, the various entries of the electromagnetic signal 204 may each correspond with a specific optical filter 206 (e.g., and correspond with a specific optical passage through the substrate of the static layer 203) for the emitted electromagnetic energy to pass through. In some cases, and for some entries, the optical filters 206 may filter, reduce the intensity of, or otherwise modify the emitted electromagnetic energy. In this way, the resulting entries of the cumulative electromagnetic signal 210 may be representative of properties of both the electromagnetic signals 204 and the static layer 203.

In some cases, the cumulative electromagnetic signal 210 exhibits various discrete intensities representative of the sum of the electromagnetic properties of the electromagnetic signal 204 and of the static layer 203. For example, each entry of the cumulative electromagnetic signal 210 may exhibit one of three discrete intensities, a first intensity (illustrated as white), a second intensity (illustrated as grey) that is greater than the first intensity, and a third intensity (illustrated as black) that is greater than the second intensity. The first intensity may correspond with an encoded value of 0 for an associated entry of the cumulative electromagnetic signal 210 and at the corresponding index position, indicating that neither the first value 212 nor the second value 214 was encoded with an entry of 1 in the corresponding index position. The second intensity may correspond with an encoded value of 1 for an associated entry of the cumulative electromagnetic signal 210 and at the corresponding index position, indicating that either the first value 212 or the second value 214 (but not both) was encoded with an entry of 1 in the corresponding index position, with the other entry being a 0. The third intensity may correspond with an encoded value of 2 for an associated entry of the cumulative electromagnetic signal 210 and at the corresponding index position, indicating that both the first value 212 and the second value 214 were encoded with an entry of 2 in the corresponding index position. In this way, the resulting intensities of the cumulative electromagnetic signal 210 may be representative of the sum of the entries of the cumulative electromagnetic signal and the static layer 203. In some cases, the third intensity (black) of the cumulative electromagnetic signal is the same intensity as the high intensity of the electromagnetic signal 204, for instance, based on the high filter not filtering, shading, or reducing the intensity. Similarly, in some cases the second intensity of the cumulative electromagnetic signal 210 is the same intensity as the low intensity of the electromagnetic signal 204, for example, based on the high filter not filtering the low intensity of the electromagnetic signal 204 and/or based on the low filter filtering the high intensity of the electromagnetic signal 204 to that of the low intensity. In some examples, the first intensity of the cumulative electromagnetic signal may be substantially zero or no intensity, such as no light being observable through the static layer for an associated index position. For instance, the low intensity of the electromagnetic signal 204, when emitted through a low filter, may produce little or no light at the cumulative electromagnetic signal 210.

The first intensity may result from an entry of the electromagnetic signal 204 of a low intensity being emitted through a low filter (of the high opacity), resulting in a lowest possible intensity for an entry of the cumulative electromagnetic signal 210. For instance, as shown for the 2⁶ index position, the resulting entry for the cumulative electromagnetic signal 210 is the first (white) intensity, indicating that the entries for both the electromagnetic signal 204 and for the static layer 203 are 0 (e.g., 0+0=0). The second intensity may result from an entry of the electromagnetic signal 204 of a low intensity being emitted through a high optical filter (of the low opacity), resulting in an intermediate possible intensity for an entry of the cumulative electromagnetic signal 210. For instance, as shown in the 2¹ index position, the resulting entry for the cumulative electromagnetic signal 210 is the second (grey) intensity, indicating that one of the entries of the electromagnetic signal 204 and static layer 203 is a 1 and the other is a 0 (e.g., in this case, 0+1=1). Additionally, the second intensity may also result from an entry of the electromagnetic signal 204 of a high intensity being emitted through a low optical filter (of the high opacity), resulting again in the intermediate possible intensity for an entry of the cumulative electromagnetic signal 210. For instance, as shown in the 2⁹ index position, the resulting entry for the cumulative electromagnetic signal 210 is also the second (grey) intensity, indicating again that one of the entries of the electromagnetic signal 204 and static layer 203 is a 1 and the other is a 0 (e.g., in this case, 1+0=1). The third intensity may result from an entry of the electromagnetic signal 204 of a high intensity being emitted through a high optical filter (of the low opacity), resulting in a highest possible intensity for an entry of the cumulative electromagnetic signal 210. For instance, as shown in the 2⁸ index position, the resulting entry for the cumulative electromagnetic signal 210 is the third (black) intensity, indicating that the entries for both the electromagnetic signal 204 and the static layer 203 are 1 (e.g., 1+1=2).

Based on the intensities of the entries of the cumulative electromagnetic signal 210 at each of the index positions, and based on multiplication factors for the index positions, a sum value 216 can be determined. In some cases, the sum value 216 may be an estimate or approximation of the mathematical sum or true sum 215 of the values 212, 214. For example, the sum value 216 may include an error when summing up the binary numbers. In this way, the encoding scheme 200 may facilitate encoding underlying values via electromagnetic properties (e.g., intensity of electromagnetic signals and opacity of optical filters) in order to sum the values through the natural, cumulative, and/or additive effect of these electromagnetic properties. As described herein, the summing of values may facilitate determining a product of those values based on the product rule of logarithms.

Also, while the encoding scheme has been described primarily as a binary scheme (e.g., for the electromagnetic signal 204 and the static layer 203), additional, or other (e.g., higher order) encoding schemes may be used. For example, a base 3, base 4, or higher order encoding scheme may be utilized, such as by utilizing 2, 3, or more light intensity values, filter opacities, or a combination thereof, for each entry. Further, in some cases negative values may be represented by one or more light intensities and/or filter opacities. Thus, the use of the term “bit” is not intended to be limiting to only binary or base 2 encoding schemes, but rather, is used to refer to a fundamental or smallest unit of information corresponding with any encoding scheme utilized in combination with the present techniques, including higher-order encoding schemes.

FIG. 3-1 illustrates an example operation 300 in which data is computed at a layer L−1 and communicated to a layer L, according to at least one embodiment of the present disclosure. For instance, the layers L, L−1 may each be layers of an AI model as described herein. The layer L−1 may include a variety of nodes N, including nodes N0, N1 up to Nn. The layer L may also include any number of nodes. In some cases, the example operation 300 of FIG. 3-1 may be representative of a conventional or typical operation of layers of an AI model.

In some cases, the layer L−1 is implemented via a GPU 311 and a memory 312. The layer L−1 may receive various activations 314, such as from one or more nodes of a previous layer (e.g., layer L−2). The operation 300 may involve computing weighted activations 317 for the activations 314, and transmitting the weighted activations 317 to the nodes of the Layer L. In this way, input information (via the activations 314) can be processed at the layer L−1 based on learned information (e.g., weights) for the layer L−1 and communicated to the layer L as part of an operation of an AI model.

In order to generate the weighted activations 317, the layer L−1 may typically rely on the GPU 311 to perform multiplication computations wherein the GPU multiplies each activation 314 by one or more corresponding weights 315. For instance, in some cases the activations 314 may each correspond to a particular node N of the layer L−1, and for each node N in the layer L to which the node N in the layer L−1 is connected, the activation 314 may be adjusted (multiplied) by the weight 315 corresponding to that connection. In some cases, the layer L−1 receives the weights 315 from another device, node, or layer, and loads the weights 315 to memory for use in performing the weighted activation multiplications. In some cases (e.g., with smaller models) the weights 315 may be stored locally by the layer L−1. More information regarding activations, weights, and connections between nodes of different layers is described in connection with FIG. 5-1.

In order to perform multiplication computations and determine the weighted activations 317, the activations 314 may typically have to be loaded into memory 312. Additionally, the weights 315 may also be loaded into memory 312. The activations 314 and weights 315 may each be stored as a corresponding matrix, or any other form for storing and indexing data. A s mentioned above, these matrices may typically be quite robust, such as including billions of entries for large AI models. Indeed, the Layers L−1, L may each include millions or billions of nodes, each corresponding to one or more activations and/or weights. Accordingly, the GPU 311 may multiply the individual activations 314 by one or more of the weights 315 to generate the weighted activations 317, which may represent a considerable amount (e.g., thousands, millions, or billions) of computations for the GPU 311 to perform, and corresponding memory access functions. For instance, the GPU 311 may perform element-wise multiplication of the activation matrix and the weight matrix. As mentioned above, computing multiplications at this scale, and in particular loading and fetching such a large volume of information from memory, can be very computationally expensive, and can represent a significant bottleneck to the efficiency of the operation of the AI model. Indeed, GPU's have often been leveraged (and in some cases specialized tensor processing units have been developed) to attempt to process larger and larger volumes of data more efficiently in order to reduce bottlenecks. The present disclosure provides advantageous techniques for performing large-scale multiplication operations without relying on conventional multiplication computations of a processor.

FIG. 3-2 illustrates an example operation 320 in which data is computed at the layer L 1 and communicated to the layer L, according to at least one embodiment of the present disclosure. In this example, the Layer L−1 may be implemented via a PU 301 and a memory 313. The PU 301 may be any type of processing component, but in at least one embodiment the PU 301 is a CPU, for example, rather than a GPU. For instance, the PU 301 may be a processing component that is not particularly configured for mass parallel operations in the way a GPU is, but rather may be a processing unit having relatively few cores, which may be facilitated by the techniques of the operation 320.

The Layer L−1 may receive activations 314, such as from a variety of nodes of a previous layer (e.g., a layer L−2), and may generate weighted activations 317, or a set of product values for the activations 314 multiplied by corresponding weights 315, for transmitting to the nodes of Layer L. However, rather than performing multiplication computations, for example with the PU 301, to generate the weighted activations 317, the layer L−1 may leverage displaying and emitting electromagnetic signals through a static layer 303 to achieve multiplication in a much more computationally efficient manner. To elaborate, the PU 301 may generate one or more electromagnetic signals 302 and may display the electromagnetic signals 302 to emit the electromagnetic signals through the static layer 303. For instance, the electromagnetic signals 302 may be displayed and emitted by a set of emitters through optical passages 305 in the static layer 303 including various optical filters 306 positioned within the optical passages 305. While the various electromagnetic signals 302 are illustrated as each comprising a single electromagnetic signal for conveying a single activation (or a logarithmic transformation thereof) and being emitted through a single optical filter 306 it should be understood that this singular nature is merely illustrative of the present techniques. Indeed, the electromagnetic signals 302 may be emitted by way of multiple entries for each electromagnetic signal 302, as described in connection with the encoding schemes herein. Accordingly, each entry may be emitted as electromagnetic energy emitted through a corresponding optical passage 305 and optical filter 306. In this way, the electromagnetic signals 302 may each comprise multiple signals or emissions for emitting through multiple corresponding optical passages 305 and optical filters 306 of the static layer 303.

In some cases, as described herein, the PU 301 may generate the electromagnetic signals 302 based on performing one or more transformations to the activations 314. For example, the PU 301 may transform the set of activations 314 into a set of logarithmic activations (e.g., log(activation)). The PU 301 may then generate the electromagnetic signals 302 based on encoding these logarithmic values into a pattern for displaying and emitting as described. While this transformation, encoding, and display of the activations 314 may involve performing various operations and/or computations with the PU 301, including memory access functions, these operations may be relatively simple operations with may be considerably more computationally efficient than are matrix multiplication computations, as described above in connection with FIG. 3-1. For example, the operation of the Layer L−1 may be implemented via a more basic and/or less sophisticate CPU rather than a more robust GPU enabled for parallelism.

As shown, the static layer 303 may be associated with the weights 315 in that the static layer 303 may be encoded to communicate the weights 315 (e.g., or a logarithmic transformation of the weights 315). For instance, the various optical passages 305 may each be configured with an optical filter 306 having an opacity selected to encode various entries of patterns of entries representing the weights 315, corresponding to the entries of the electromagnetic signals 302 to be transmitted therethrough. In this way, the static layer 303 may not necessarily be a processing device or even an electronic device, but rather may be a physical substrate or component through which light may be transmitted in order to accomplish the summation/multiplication techniques described herein.

In some cases, the static layer 303 is encoded based on a transformation of the weights 315, or a set of logarithmic weights as described herein. For instance, in various cases the weights 315 may be learned and/or static information, and the set of logarithmic weights can be hard coded or hard formed into the static layer 303 by the optical filters 306. For instance, because the weights 315 are static, and it may not be necessary for the weights 315 to change such that the static layer 303 can be (e.g., permanently) configured in a physical way based on the weights 315. Thus, because the static layer 303 represents the weights 315 in a non-software, non-computing, and/or non-electronic way, the weights 315 can be implemented to perform multiplication as described without requiring any corresponding computation and/or memory access functions, providing significant improvements over the bottle neck issues associated with conventional techniques. Additionally, the analog or non-electric nature of the static layer 303 may provide energy efficiency benefits to the operation of a computing system (e.g., a datacenter) in which the present techniques are implemented to operate an AI model.

Based on the electromagnetic signals 302 being emitted through the static layer 303, a set of cumulative electromagnetic signals 310 may be generated which may be based on a combination of the electromagnetic properties of the electromagnetic signals 302 (intensity) and of the optical filters 306 (opacity). Thus, the cumulative electromagnetic signals 310 may represent or may be utilized to convey various weighted activations 317, or the product of the corresponding pairs of activations 314 and weights 315. For example, a set of sum values may be decoded from the cumulative electromagnetic signals 310 representing the sum of the underlying (e.g., logarithmic) activation and weight values. This may be performed at scale such that an encoding for each activation 314 may be summed one or more times with encodings of corresponding weights 315. Accordingly, the cumulative electromagnetic signals 310 may be observed or received through the static layer 303, which may represent corresponding sums (e.g., via a set of sum values) of encodings for each activation-weight pair.

The cumulative electromagnetic signals 310 may be detected, observed, measured, or otherwise received by one or more image sensors 308. In at least one embodiment, each entry of each cumulative electromagnetic signal 310 may correspond with a distinct image sensor 308, or other configurations of image sensors 308 may be implemented, such as one image sensor 308 per weighted activation value (e.g., to detect the multiple entries of the value). The image sensors 308 may be associated with the layer L−1, such that the layer L−1 receives or identifies the cumulative electromagnetic signal 310. For example, in some cases the image sensors 308 may be operated or implemented by the PU 301. In some cases, a separate PU 321 or other computing component may operate the image sensors 308. In some cases, the PU 321 may be an in-line processing component which may process the received cumulative electromagnetic signals 310 in line as the various image sensors 308 measure the cumulative electromagnetic signals 310, such as via a field programmable gate array (FPGA) or application-specific integrated circuit (ASIC) for processing images and performing other operations. In this way, the cumulative electromagnetic signals 310 may be observed. In some cases, the image sensors 308 are included in or associated with the Layer L, and the layer L may directly observe the cumulative electromagnetic signals 310 and determine the resulting weighted activations. For instance, such a configuration may reduce the amount of data transmitted between the layers based on the Layer L directly obtaining the weighted pairs from observing the cumulative electromagnetic signals 310.

Based on the cumulative electromagnetic signals, the layer L may determine or infer the corresponding products of the activations 314 and weights 315. For example, as mentioned, the electromagnetic properties of the electromagnetic signals 302 and the optical filters 306 of the static layer 303 may naturally combine or sum to represent a sum of the underlying values or numbers (e.g., decimal values) that they represent. Because the electromagnetic signals 302 and static layer 303 may be encoded based on logarithmic values of the activations 314 and weights 315, the sums as detected through the cumulative electromagnetic signal 210 may be sums of logarithmic activation-logarithmic weight pairs. By leveraging the product rule for logarithms, the product of the activation-weight pairs can be determined from this sum. For example, the Layer L−1 or the layer L (e.g., via the PU 301, PU 321, or other processing unit) may exponentiate the detected logarithmic activation-logarithmic weight sums to reverse transform these sums to a corresponding activation-weight product. In at least one embodiment, the logarithmic transformations of the activations 314 and weights 315 may be based on logarithms having a base of 2, or a binary logarithm. Accordingly, a processing unit (e.g., operating based on binary bit values) may be readily equipped to efficiently exponentiate and/or reverse transform the binary logarithm values based simply on bit shifting. Accordingly, the reverse transformation of the detected logarithmic activation-logarithmic weight sums to activation-weight products may be easily and efficiently performed.

In this way, multiplication may be performed at scale of the activations 314 and their corresponding weights 315 based on displaying and emitting encoded electromagnetic signals through a static layer and observing cumulative electromagnetic signals. Indeed, rather than performing mass matrix multiplication by relying on processing hardware (e.g., GPUs), all of the multiplication computations may be performed at once by leveraging the summation effect of the electromagnetic properties of electromagnetic signals and optical filters, and notably, without a PU having performed the actual multiplication computation.

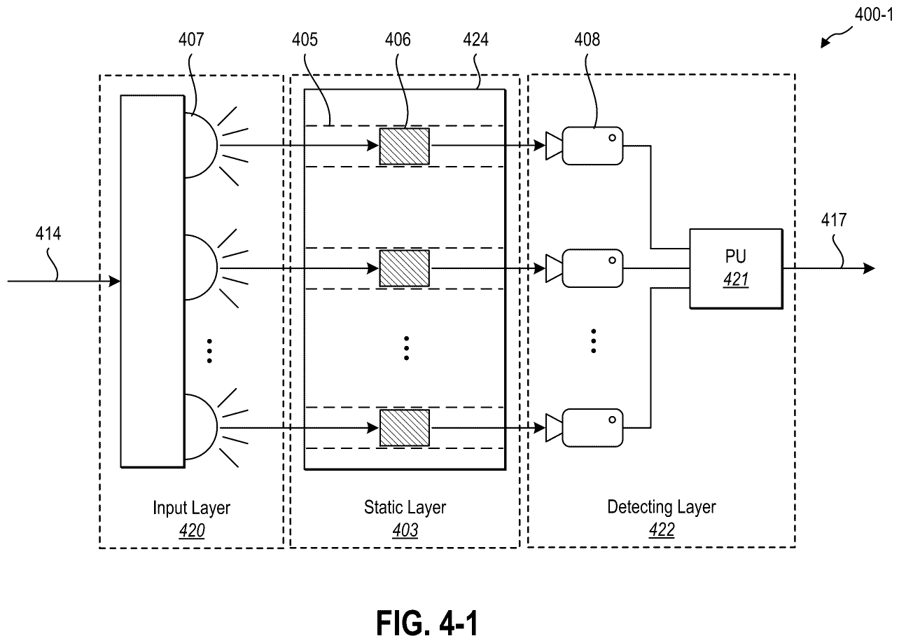

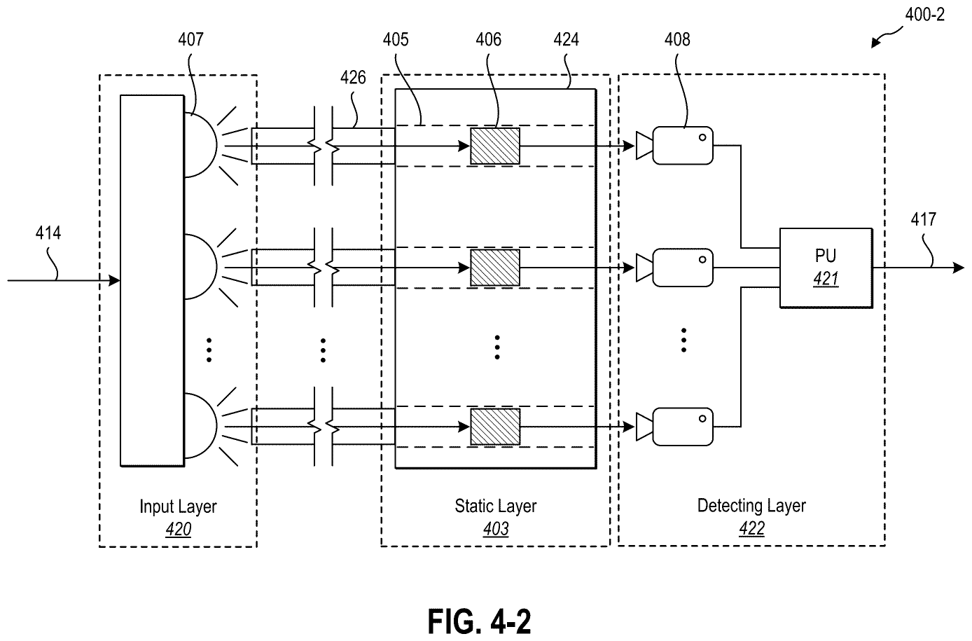

FIG. 4-1 illustrates an example of a device 400-1 for performing collective operations as described herein, according to at least one embodiment of the present disclosure. FIG. 4-2 illustrates an example of another device 400-2 for performing collective operations as described herein. The device 400-1 includes an input layer 420, a static layer 403 and a detecting layer 422. In some cases, each of the layers may be implemented as a discrete chip, die, wafer, or substrate such that the layers shown are represented as different physical layers. In some cases, two or more of the layers may be implemented in a same chip, die, wafer or substrate, such that the two or more layers may comprise a same physical structure, but may conceptually be implemented as different layers within the structure. These layers (and the associated components of the layers) may be connected, joined, stacked, or bonded so as to comprise a single, connected unit, or one or more of the layers (or one or more associated components of a layer) may be separately implemented and/or may not be integrally connected thereto. The device may facilitate receiving one or more input values 414 and generating one or more weighted input values 417.

The input layer 420 may include a display having one or more emitters 407. The emitters 407 may be light emitting diodes (LED) such as micro LEDs, bulbs projectors, lasers, or other light-producing devices, and combinations thereof. The emitters may each emit electromagnetic energy (e.g., light) at various discrete levels of intensity (e.g., 2, non-zero intensities as described in various embodiments herein). For instance, each of the emitters 407 may correspond with a (single) entry of an electromagnetic signal and may display and/or emit electromagnetic energy in accordance with an encoding of the electromagnetic signal for representing an underlying value. In some cases, one or more emitters 407 may be implemented as multiple emitters, such as a set or cluster of emitters for displaying a single entry.

In some cases, the input layer is implemented via a substrate, chip, die, or other material or base upon which the emitters 407 are positioned and attached. For example, the input layer may include a chip having a circuit formed thereon including the emitters 407. The emitters 407 and the input layer 420 may be configured in a pattern, array, grid, or other shape or arrangement for emitting the entries of electromagnetic signals at particular positions. The input layer 420 may include a processing unit and a memory (not shown) for controlling and/or driving the emitters 407, receiving and/or transforming the input value(s) 414, among other operations as described herein.

The input layer 420 may be positioned and configured such that the emitters 407 display and emit electromagnetic energy toward and/or through the static layer 403. For example, the input layer 420 may be joined, bonded, or connected to the static layer 403, or may be otherwise positioned with respect to the static layer 403. The static layer 403 may include a physical substrate 424, material, or device. For example, the substrate 424 may be a silicon substrate, semiconductor, epoxy, molding compound, glass, plastic, rubber, polymer, wood, ceramic, or any other substrate material. The static layer 403 includes various optical passages 405 formed in and through the substrate 424. For example, the optical passages 405 may be optical through silicon vias (TSVs) or other conduits, holes, or openings through the substrate of the static layer 103, and combinations thereof. For instance, in some cases TSV's may be formed through silicon and other substrates having conductive elements for transmitting electrical signals. In the context of the present disclosure, the optical passages 405 may be formed through substrates in a similar manner to that of electrical TSVs, but without the resulting through-via being coated or filled with a conductive material such that a void or opening exists through the substrate through which electromagnetic energy may pass. The use and/or description of the optical passages being optical TSV s should not be understood to be limited to only silicon substrates, but the technique may be applicable to substrates of any material. The optical passages 405 may be configured such that electromagnetic energy (e.g., light) may enter and pass therethrough. For instance, the emitters 407 may be optically coupled to the optical passages 405 such that electromagnetic energy emitted from one emitter (or cluster of emitters) enters a corresponding optical passage 405. Further, electromagnetic energy from adjacent or nearby emitters may not enter into an optical passage with which they are not associated. In this way, the electromagnetic signals may be emitted from the emitters 407 and may travel to and through particular optical passages 405 to which they correspond, in accordance with the techniques described herein.

In some cases, the emitters 407 are optically coupled to the optical passages 405 based on the emitters 407 being positioned near, adjacent, within, or otherwise directly interfacing with associated optical passages 405. For example, the input layer (e.g., emitters and/or display) may be connected, bonded, or joined to the substrate 424 such that the emitters 407 align and/or interface with the corresponding optical passages 405. As shown in FIG. 4-2, in some cases the input layer may be optically coupled to the static layer 403 by one or more optical fibers 426, or other waveguide or light-directing component. For example, the emitters 407 may be optically coupled to the optical passages 405 based on being optically coupled to the optical fibers 426, and the optical fibers 426 being optically coupled to the optical passages 405. To elaborate, the input layer may be optically coupled to the optical fibers such that electromagnetic energy emitted from the input layer (e.g., from the emitters) enters a corresponding optical fiber 426, which may direct the electromagnetic signal in a path along the optical fiber 426. The electromagnetic signal may then exit the optical fiber 426 and may enter a corresponding optical passage 405 in the static layer 403 based on the optical fiber 426 being optically coupled to the optical passage 405. In some cases, the optical fibers 426 are optically coupled to the static layer 403 and/or the input layer based on being physically connected, bonded, or adhered to, based on abutting or otherwise contacting, or based on being positioned relative to an associated emitter and/or optical passage (and combinations thereof). In this way, electromagnetic energy emitted from the emitters 407 may travel through the optical fibers 426 and may enter the optical passages 405. The optical fibers 426 may facilitate positioning the input layer 420 separately and/or at a distinct location from the static layer 403. For instance, the input layer 420 may not be directly connected to the static layer 403, but rather, may be otherwise positioned. For instance, the input layer 420 may be positioned a distance from the static layer 403 and/or at an angle relative to the static layer 403. In this way and through the various embodiments just discussed, the emitted electromagnetic energy of a specific entry be emitted from an emitter 407 and may pass to (e.g., only) a corresponding optical passage 405 of the static layer 203.

The static layer 403 may include various optical filters 406. The optical filters 406 may be positioned within, at, over an opening of, or otherwise associated with the optical passages 405. For instance, the optical filters 406 are shown as being positioned within and interior of the optical passages 405, but the optical filters 406 may be otherwise positioned such that the electromagnetic energy traveling through the optical passages 405 passes through or interacts with the optical filters 406. The optical filter(s) 406 may be components which may filter, adjust, reduce, block, or otherwise modify the intensity of the electromagnetic energy. For example, the optical filters 406 may have a structure, tint, makeup, or other feature for limiting (in some cases) the brightness of the electromagnetic energy traveling through the optical passages 405. The optical filters 406 may be made of any suitable filtering medium, such as a polymer, glass, plastic, or other materials. In some cases, the optical filter(s) 106 are implemented based on filling (e.g., partially or entirely) the optical passages 105 with a filler material such as a bonding material, overmolding material, underfill material, epoxy, or other material, for example, which may be typically known and/or utilized in the manufacture of computing chips and/or dies. The optical filters 406 may be implemented each with a specific opacity in accordance with an encoding of the static layer 403 to represent one or more underlying values (e.g., learned parameters). The opacity or filtering index of the optical filters 206 may be achieved based on any suitable technique.

The static layer may be characterized as “static” in that the static layer encodes or represents the learned parameters as described herein, which values themselves may be static, learned, and/or unchanging. For instance, the static layer may encode various static weights that have been learned as part of a training of an AI model. In some cases, the static layer is not necessarily static in a physical sense in that the static layer may not physically change. For example, in some cases the static layer (e.g., a chip or substrate implementing the static layer) may be exchanged or swapped with another (chip or substrate) for representing a different collection of weight values. In some cases, one or more of the optical filters as described herein may be changeable and/or dynamic, such as by being operable for changing an opacity or other characteristic of the filter, such that the static layer may not necessarily be static in a physical sense.

As mentioned above, the device 400-1 includes a detecting layer 422. The detecting layer may be implemented via one or more image sensors 408. The image sensors 408 may include one or more of cameras, photodetectors, photodiodes, quantum dots, or other image sensing devices, and combinations thereof. For example, an image sensor, such as a photodetector may be a sensor, measurement device, or other device which operates on the principle of light-induced conductivity changes in a semiconductor material such that, when photons strike the material, they excite charge carriers, reducing the material's resistance. Common materials include amorphous silicon, cadmium sulfide (CdS), and lead sulfide (PbS). In some cases, image sensors (e.g., photodetectors) can be fabricated directly on a substrate or layer as described herein, such as on a microchip or die. The image sensors 408 may be configured to detect, differentiate, and measure various discrete intensities of electromagnetic energy. As described herein, cumulative electromagnetic signals may be emitted from the static layer 403 and/or may be observable through the static layer 403 at the detecting layer 422. The image sensors 408 may be configured to observe the cumulative electromagnetic signals and determine corresponding intensities thereof. In some cases, each optical passage 405 may correspond to a distinct image sensor 408. In some embodiments, an image sensor 408 may be associated with multiple optical passages 405, for example, for observing the electromagnetic energy for multiple entries through the static layer 403. In some cases, the image sensors 408 may be implemented via a substrate or base material, such as a chip or wafer having various image sensors positioned thereon. For instance, the substrate of the detecting layer 422 may be bonded, joined, or otherwise connected to the substrate 424 of the static layer 403. In some cases, the image sensors 408 may be optically connected to the optical passages 405, such as being directed at, adjacent, contacting, or otherwise positioned such that electromagnetic energy traveling through and/or emitting from the optical passages may be received at the associated image sensors 408. In some cases, the image sensors 408 may be optically coupled to the optical passages 405 with one or more optical fibers. For instance, the detecting layer 422 may be discretely positioned a distance from and/or at an angle to the static layer 403.

In this way, the image sensors 408 may detect and measure the intensity of the cumulative electromagnetic signals resulting from the electromagnetic signals being emitted through the static layer 403. The detecting layer 422 may include a PU 421 which may perform logic and/or processing functions in connection with the image sensors 408 in order to determine light intensities, decode values, sum values, etc., similar to that described in connection with one or more embodiments herein.

FIG. 5-1 illustrates an example of various nodes N of a layer L−1 and various nodes M of a layer L, and connections therebetween, according to at least one embodiment of the present disclosure. In this example, the layer L−1 includes nodes N₀, N₁, N₂, and N₃, and the layer L includes nodes M₀, M₁, M₂, M₃, and M₄. The layers L−1 and L may be layers of an AI model which may include any number, and often many (e.g., thousands, millions, or billions) of nodes, but for simplicity and illustrative purposes, a select few nodes are shown and described.

Each node N of the layer L−1 may receive an activation a, such as from a previous layer (e.g., layer L−2). In some cases, each activation a may be a sum of a collection of several weighted activations, such as a sum of a weighted activation from each node of the previous layer. The layer L−1 may perform various computations on the activations a as described herein, such as to produce weighted activations for each node N to transmit to the nodes M of the layer L. Typically, the nodes of each layer are connected to each of the nodes of the next layer in an all-to-all network configuration. Accordingly, each node N of the layer L−1 is connected to each node M of the layer L. The connections between the node N₀ of layer L−1 and each of the nodes M₀-M₄ of the layer L are shown in FIG. 5-1 for simplicity, but it should be understood that similar connections exist for each of the nodes N₁-N₃ of the layer L−1.

Each of the connections of the node N₀ may correspond to a weight w. For example, while the activation a₀ may be the same for the node N₀, depending on the receiving node, the activation a₀ may be weighted by a unique weight w corresponding to the receiving node N. For instance, a weight w_{0,0} may correspond to the connection between the node N₀ of the layer L−1 and the node N₀ of the layer L. Similarly, weights w_{0,1}; w_{0,2}; M_{0,3}; and W_{0,4} may correspond to the connections to the nodes M₁-M₄, respectively, of the layer L.

Typically, an activation is equal to an activation function (Ø) on the sum of all weighted inputs or weighted activations (aw) to a target neuron with some bias b. For example, for node M₀ of layer L, the activation

$${a}_{0}^{( l )} = ∅ ( {a}_{0}^{( l - 1 )} {w}_{0 , 0}^{( l )} + {a}_{1}^{( l - 1 )} {w}_{1 , 0}^{( l )} + {a}_{2}^{( l - 1 )} {w}_{2 , 0}^{( l )} + … + {b}^{( l )} ) .$$

The inputs

$$( e . g . , {a}_{0}^{( l - 1 )} , {a}_{1}^{( l - 1 )} , {a}_{2}^{( l - 1 )} , etc . )$$

in this example are the set of values for which one needs to predict an output value. These can be viewed as features or attributes included in the data. The weights

$$( e . g . , {w}_{0 , 0}^{( l )} , {w}_{1 , 0}^{( l )} , {a}_{2 , 0}^{( l )} , etc . )$$

are values that are attached to each input to convey the importance of the corresponding input or feature in predicting the final output. The bias (e.g., b^{(l)}) can be used to shift the activation function towards left or right. The weights and the bias are parameters that have been learned during training of the AI model.

The activation function (e.g., Ø) is used to introduce non-linearity in the model and the summation function is used to bind the weights and inputs together. Examples of activation functions include rectified linear unit (ReLU) activation function, leaky ReLU, parametric ReLU, Gaussian-error linear unit (GELU) activation function, and other variants of ReLU. Moreover, aside from ReLU any other appropriate non-linear or linear activation functions may be used. In this example, in order to calculate the summation

$$( {a}_{0}^{( l )} ) ,$$

one needs information across all of layer L−1, even if the neurons in layer L−1 are partitioned across processing units as part of parallelism. This means that in this example all of the layer L−1 activations would have to be supplied to each processing unit that would calculate the activations for each of layers L's nodes.

In this way, each node may correspond with a single activation a, but may compute and transmit many weighted activations equal to the number of nodes in the receiving layer. For instance, the layer L−1 having 4 nodes and the layer L having 5 nodes may result in 20 weighted activations to compute at layer L−1 and transmit to the nodes of layer L. This all-to-all network configuration of the nodes N further highlights the sheer volume of data to be processed at each layer, which leads to the bottleneck issues discussed herein.

FIG. 5-2 illustrates an operation 500 in which weighted activations are computed at the layer L−1 and transmitted to the layer L, according to at least one embodiment of the present disclosure. The nodes N₀-N₃ of the layer L−1 may be implemented via a memory 502 and PU 501. The layer L−1 may receive activations a₀-a₃ for the nodes N₀-N₃ for the purpose of generating weighted activations to transmit to the nodes M₀-M₄ of the layer L. The weighted activations may be determined based on the electromagnetic property summation techniques as described herein, for example, rather than the PU 501 performing multiplication computations.

The PU 501 may generate an activation matrix 524 which may be a table or matrix (or other form) which includes a set of activation values, such as a set of activations a₀-a₃. As shown, each row in the activation matrix 524 may include entries corresponding to the activations a₀-a₃, and the rows may be repeated a number of times corresponding to the number of nodes N in the layer L. It should be recognized that the concept of repetition in this context can be achieved through the dispersion of a singular light beam. For instance, the repeating nature of the rows of the activation matrix 524 may be achieved by generating separate, repeated electromagnetic signals to represent each row, or alternatively, an electromagnetic signal representing the repeating row may be dispersed, divided, or duplicated (e.g., optically) a number of times for representing the repeated rows. In this case, there are 5 nodes M₀-M₄ in the layer L, and accordingly each row of the activation matrix 524 may correspond with a receiving node of the layer L, and each column of the activation matrix 524 may correspond with a sending node N of the layer L−1. The activation matrix 524 is illustrated as containing the activations a₀-a₃, but it should be understood that, in some cases, the activation matrix 524 (or another matrix) may be generated by the PU 501 having entries corresponding to the logarithmic transformation of the activations a₀-a₃, rather than the activations themselves.

Similarly, a matrix 525 may be a table or matrix (or other form) including a set of weight values, such as a set of weights w_{0,0}-w_{3,4} corresponding to each of the connections between nodes of adjacent layers as described in connection with FIG. 5-1. For example, each connection may be associated with a unique weight w. Accordingly, the activation a for each node N of the layer L−1 may correspond with several weights, one for each node of the layer L. For example, each entry in the weight matrix 525 may correspond to a particular connection between nodes of the layers L−1 and L. The weight matrix 525 and the activation matrix 524 may accordingly have a same size such that element-wise multiplication may be performed for corresponding pairs of entries in each matrix. As described, in some cases the weight matrix 525 (or another matrix) may be generated having entries corresponding to the logarithmic transformations of the set of weight values w_{0,0}-w_{3,4}, rather than the weight values themselves.

In some cases, similar to one or more embodiments described herein, the activation matrix 524 may be encoded as a set of electromagnetic signals 504. For instance, the electromagnetic signals may represent each of the entries of the weight matrix 525 as a pattern of several (e.g., 16) entries encoded via a light intensity as described herein. In this way, the activation matrix 524 (e.g., or a logarithmic transformation of the activation matrix 524) may be displayed and emitted corresponding to the activations associated with the nodes of layer L−1.

In some cases, the weight matrix 525 (e.g., or a logarithmic transformation of the weight matrix 525) may be encoded into a static layer 503. More specifically, a substrate of the static layer 503 may include a set of optical passages corresponding with the various entries of the electromagnetic signals 504. Each of the optical passages may have an optical filter therein which may have a selected opacity for encoding the weights of the weight matric 525 as corresponding entries in an encoding scheme. While the static layer 503 is illustrated as having only one optical passage per activation-weight value pair of the activation matrix 524 and weight matrix 525, this ratio is merely illustrative, and it should be understood that the static layer 503 includes a corresponding optical passage for each entry used to encode the weight values (corresponding to the same number and arrangement of the entries used to encode the activation values).

The electromagnetic signals 504 may be emitted through the static layer 503, and more specifically through the optical filters in the optical passages, to create a set of cumulative electromagnetic signals 506. For example, the electromagnetic signals 504 as emitted through the optical filters (e.g., or as observed through the optical filters) may be adjusted, changed, or modified based on the encoded filter opacities and the intensity properties of the electromagnetic signals 504 may be combined (e.g., summed) with the opacity properties of the optical filters to produce the cumulative electromagnetic signals 506. An image sensor 508 (e.g., multiple image sensors 508 as described in connection with one or more embodiments herein) may observe the cumulative electromagnetic signals 506 at or through the static layer 503 and may infer the summations of the underlying values, which may be utilized to determine the products of the weights wand activations a as described herein.

Accordingly, a weighted activation matrix 517 may be generated having entries that correspond with an element-wise multiplication of the entries of the activation matrix 524 and the entries of the weight matrix 525. For instance, the image sensor(s) 508 may have an inline processing component which may perform bit shifting (e.g., or other suitable transformation) in order to convert the logarithmic expressions conveyed via the cumulative electromagnetic signals 506 to the associated products of weight-activation pairs. In this way, the weighted activations for each connection may be transmitted to the layer L. For example, the layer L−1 may transmit the weighted activation matrix 517 to the layer L. In some cases, the layer L may directly detect and determine the weighted activations, for example, based on the image sensor 508 being incorporated or associated with the layer L. In some cases, the various weighted activations for a particular receiving node (e.g., the weighted activations contained in a given row of the weighted activation matrix 517) may be summed. For example, the Layer L may sum the weighted activations for a particular receiving node after receiving the weighted activation matrix 517. In some cases, the layer L−1 (e.g., via the image sensor 508) may sum the rows of the weighted activation matrix 517 and may transmit only these summed weighted activations for each receiving node N to the layer L. By summing the weighted activations at the layer L−1 and only transmitting this summed weighted activation value (e.g., rather than each of the weighted activations), the total volume of data to be transmitted in the network may be reduced, which may provide further efficiency improvements.

In some cases, the various weighted activations as determined in the operation 500 may further be implemented in an operation to perform summation of the weighted activations via electromagnetic signals. For example, rather than utilizing a processing component to compute sums of the rows of the weighted activation matrix 517, a summation operation may be performed based on leveraging the additive properties of electromagnetic energy to sum the various weighted activations for a receiving node using electromagnetic signals. For example, one or more processing units (e.g., or the PU 501) may cause (e.g., via one or more projectors or other display devices) encoded electromagnetic signals corresponding to each weighted activation to be displayed on a shared screen area, or meta space. The encoded electromagnetic signals may be overlaid or collocated upon one another corresponding to weighted activations to be summed for a particular receiving node. For instance, in the example shown in FIG. 5-2, encoded electromagnetic signals corresponding to the weighted activations a₀w_{0,0}; a₁w_{1,0}; a₂w_{2,0}; and a₃w_{3,0} may be displayed and superimposed to produce a resulting cumulative electromagnetic signal which represents the sum of these 4 weighted activations. For instance, the intensity of various corresponding entries of the underlying electromagnetic signals, when displayed at a common space, may add or aggregate to a greater intensity, which can be decoded to infer summing of the (e.g., 1's and 0's) of the entries similar to that described in connection with FIG. 2. Accordingly, the layer L may be configured to detect and decode this cumulative electromagnetic signal, such that the summed weighted activation for node N₀ of layer L may be determined, for example, without a PU performing the actual computation, and without transmitting the data between layers by conventional means (e.g., serializing and transmitting through a network). Details related to summing weighted activations using electromagnetic signals in this way are described in U.S. patent application Ser. No. 18/526,186, filed Dec. 1, 2023 and Ser. No. 18/737,539, filed Jun. 7, 2024, the entireties of which are incorporated herein by reference.

In this way, by leveraging electromagnetic signals and the ability of electromagnetic properties of the electromagnetic signals (intensity) to combine with electromagnetic properties of the optical filters (opacity), bottlenecks and other latency issues associated with AI models may be reduced, enabling faster, larger, and more robust AI models. In particular, latency issues related to mass multiplication at AI model layers may be mitigated, providing efficiency benefits for AI model processing.

FIG. 5-3 illustrates an example of performing multiplication based on the summation of electromagnetic properties, according to at least one embodiment of the present disclosure. An activation a₀ and corresponding weight w_{0,0} may be associated with a node N of an AI layer as discussed above. Accordingly, in order to process information (e.g., input embeddings) through the AI model, it may be necessary to multiply the activation a₀ by the weight a_{0,0}. In order to multiply these values, the activation a₀ may be transformed into a logarithmic activation 532, and the weight w_{0,0} may be transformed into a logarithmic weight 533. The logarithmic activation 532 and logarithmic weight 533 may be based on logarithms of any base value, but in at least one example are logarithms of base 2, or binary logarithms. As an example, the activation a₀ and the weight w_{0,0} may each be a decimal number which may be transformed by taking the logarithm (e.g., base 2) of those decimal numbers.

The logarithmic activation 532 may be encoded into an electromagnetic signal 534. For example, the electromagnetic signal 534 may be a pattern of various entries which may be displayed having selected light intensities for representing a bit sequence (e.g., in binary, or other-order encoding scheme). Similarly, the logarithmic weight 533 may be encoded into a static layer 535. For example, the static layer 535 may include various optical filters 536 which may form a pattern of various entries having selected opacity for representing a bit sequence. By displaying the electromagnetic signal 534 and emitting it through the static layer 535, a cumulative electromagnetic signal 537 is generated, the various entries of which may combine, add, or sum the entries of the electromagnetic signal 534 with associated entries of the static layer 535.

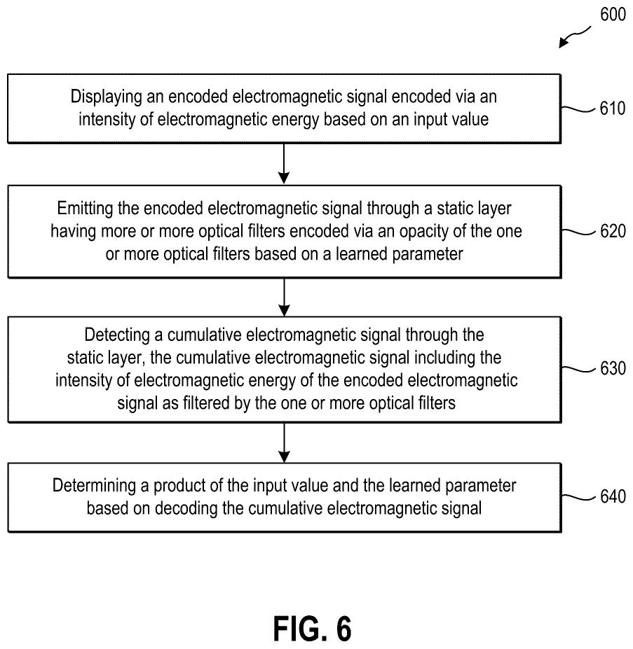

An image sensor 538 may observe the cumulative electromagnetic signal 537, which may be decoded to infer a sum value 542 being a sum of the logarithmic activation 532 added to the logarithmic weight 533. Based on the product rule of logarithms, the sum value 542 of the logarithmic activation 532 and the logarithmic weight 533 can be expressed as a the logarithm 544 of the product of the activation a₀ and the weight w_{0,0}. Further, by reverse transforming 546 the logarithmic transformation, or in other words by exponentiating the logarithm 544 with the value of the base of the logarithm 544, the product 548 of the activation a₀ and the weight w_{0,0} can be determined, which may be a weighted activation for a connection between node N₀ of layer L−1 and node M₀ of layer L. In a particular example, binary logarithms may be utilized (e.g., logarithms of base 2), which may facilitate performing the reverse transformation 546. For instance, because computers represent numbers in a binary system, exponentiating a base value of 2 can be performed simply through bit shifting. In this way, multiplication operations may be performed based on adding, combining, or summing the electromagnetic properties of the electromagnetic signals and static layers, for example, rather than relying on a processing unit to perform multiplication computations. While a single multiplication is shown in FIG. 6-3, it should be understood that this technique may be performed at scale, for example, by displaying and emitting numerous encoded electromagnetic signals of logarithmic activations through one (or multiple, in parallel) static layers encoded with logarithmic weights.

FIG. 6 illustrates a flow diagram for a method 600 or a series of acts for optical multiplication, according to at least one embodiment of the present disclosure. While FIG. 6 illustrates acts according to one embodiment, alternative embodiments may add to, omit, reorder, or modify any of the acts of FIG. 6.

In some embodiments, the method 600 includes an act 610 of displaying an encoded electromagnetic signal encoded via an intensity of electromagnetic energy based on an input value.

In some embodiments, the method 600 includes an act 620 of emitting the encoded electromagnetic signal through a static layer having one or more optical filters encoded via an opacity of the one or more optical filters based on a learned parameter.

In some embodiments, the method 600 includes an act 630 of detecting a cumulative electromagnetic signal through the static layer, the cumulative electromagnetic signal including the intensity of electromagnetic energy of the encoded electromagnetic signal as filtered by the one or more optical filters.

In some embodiments, the method 600 includes an act 640 of determining a product of the input value and the learned parameter based on decoding the cumulative electromagnetic signal.

In some embodiments, the method 600 further includes displaying the encoded electromagnetic signal as a pattern of one or more entries displayed at a set of one or more emitters, and emitting electromagnetic energy of a selected intensity for each entry at the set of one or more emitters through one or more optical passages in the static layer, wherein the one or more optical filters are positioned within the one or more optical passages. In some embodiments, emitting the encoded electromagnetic signal through the static layer includes transmitting the encoded electromagnetic signal displayed at the set of one or more emitters through one or more optical fibers optically coupling the set of one or more emitters to the one or more optical passages.

In some embodiments, the method 600 further includes detecting the intensity of a set of one or more entries of the cumulative electromagnetic signal with one or more photodetectors, wherein each entry of the cumulative electromagnetic signal has an intensity of a first intensity, a second intensity greater than the first intensity, or a third intensity greater than the second intensity. In some embodiments, the one or more optical filters include one or more optical filters being a low optical filter having a high opacity and one or more optical filters being a high optical filter having a low opacity less than the high opacity. For instance, the method 600 further includes, for a first subset of entries of the set of one or more entries of the encoded electromagnetic signal, emitting electromagnetic energy through the static layer as electromagnetic energy having a low intensity, and for a second subset of entries of the set of one or more entries of the encoded electromagnetic signal, emitting electromagnetic energy through the static layer as a high intensity greater than the low intensity. In some embodiments, the method 600 includes, when an entry of the encoded electromagnetic signal is displayed at the low intensity and emitted through the low optical filter, generating an entry of the cumulative electromagnetic signal having the first intensity. In some embodiments, the method 600 further includes, when an entry of the encoded electromagnetic signal is displayed at the low intensity and emitted through the high optical filter, generating an entry of the cumulative electromagnetic signal having the second intensity. In some embodiments, the method 600 further includes, when an entry of the encoded electromagnetic signal is displayed at the high intensity and emitted through the low optical filter, generating an entry of the cumulative electromagnetic signal having the second intensity. In some embodiments, the method 600 further includes, when an entry of the encoded electromagnetic signal is displayed at the high intensity and emitted through the high optical filter, generating an entry of the cumulative electromagnetic signal having the third intensity.

In some embodiments, the method 600 further includes receiving the input value and generating the encoded electromagnetic signal based on a logarithmic transformation of the input value, and wherein the static layer is an encoded representation of a logarithmic transformation of the learned parameter. In some embodiments, the cumulative electromagnetic signal represents a sum value of a sum of the logarithmic transformation of the input value and the logarithmic transformation of the learned parameter, and determining the product includes exponentiating the sum value, the sum value being a logarithmic value.

In some embodiments, the method 600 includes transforming a set of inputs for a set of nodes of a first layer of an artificial intelligence (AI) model into a set of logarithmic inputs for the set of nodes; encoding the set of logarithmic inputs into a set of encoded electromagnetic signals via an intensity of electromagnetic energy; displaying the set of encoded electromagnetic signals at a set of emitters; emitting the set of encoded electromagnetic signals through a set of optical passages in a substrate of a static layer, the set of optical passages including a set of optical filters encoding a set of logarithmic learned parameters transformed from a set of learned parameters corresponding to the set of nodes; detecting a set of cumulative electromagnetic signals through the static layer including the intensities of electromagnetic energy for the set of encoded electromagnetic signals as filtered by the set of optical filters; decoding a set of sum values from the set of cumulative electromagnetic signals, each sum value being a sum of one logarithmic input of the set of logarithmic inputs and a corresponding logarithmic learned parameter of the set of logarithmic learned parameters; and determining a set of weighted input values based on exponentiating the set of sum values, each of the weighted input values being a product of an input of the set of inputs and a corresponding learned parameter of the set of learned parameters. In some embodiments, the method 600 includes summing the set of weighted input values to generate a sum value for the set of nodes, and transmitting the sum value to one or more nodes of a second layer of the AI model.

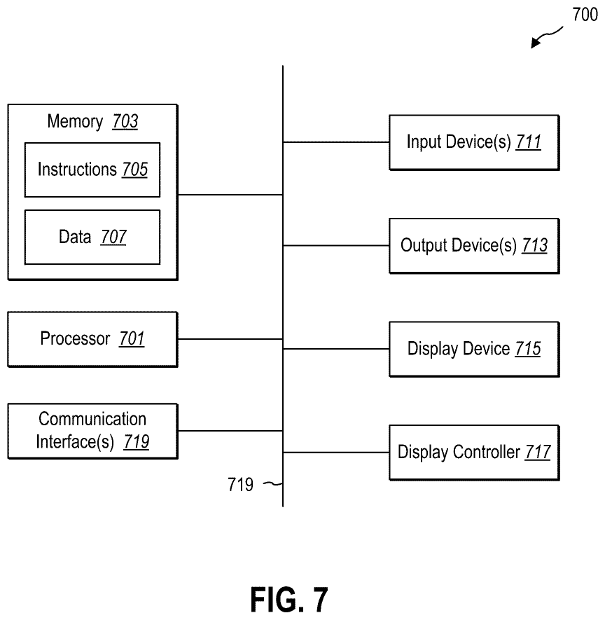

Turning now to FIG. 7, this figure illustrates certain components that may be included within a computer system 700, according to at least one embodiment of the present disclosure. One or more computer systems 700 may be used to implement the various devices, components, and systems described herein.

The computer system 700 includes a processor 701. The processor 701 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random-access memory (RA M), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

### INDUSTRIAL APPLICABILITY

The following description from ¶¶ [0110]-[0129] includes various embodiments that, where feasible, may be combined in any permutation. For example, the embodiment of ¶

may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a device for performing collective operations using electromagnetic energy includes an input layer including at least one emitter for displaying electromagnetic signals encoded via an intensity of electromagnetic energy, wherein the at least one emitter is configured to emit electromagnetic energy at a low intensity, and to emit electromagnetic energy at a high intensity that is greater than the low intensity, and a static layer comprising a substrate having at least one optical passage therethrough corresponding with and optically coupled to the at least one emitter and optically coupled to the input layer such that the at least one emitter emits electromagnetic energy into the at least one optical passage, wherein the at least one optical passage includes at least one optical filter and wherein the static layer is encoded via an opacity of the at least one optical filter.

In some embodiments, the device further includes a detecting layer including at least one photodetector corresponding with the at least one optical passage and positioned such that the at least one photodetector detects the intensity of electromagnetic energy passing through the at least one optical filter.

In some embodiments, the low intensity is non-zero.

In some embodiments, the at least one optical passage includes a plurality of optical passages each having an optical filter that is one of: a low optical filter that has a high opacity, or a high optical filter that has a low opacity that is less than the high opacity.

In some embodiments, the optical filters of the plurality of optical passages are configured such that: electromagnetic energy at the low intensity passing through an optical passage with the low optical filter generates a cumulative electromagnetic signal having a first intensity; electromagnetic energy at the low intensity passing through an optical passage with the high optical filter generates a cumulative electromagnetic signal having a second intensity greater than the first intensity; electromagnetic energy at the high intensity passing through an optical passage with the low optical filter generates a cumulative electromagnetic signal having the second intensity; and electromagnetic energy at the high intensity passing through an optical passage with the high optical filter generates a cumulative electromagnetic signal having a third intensity greater than the second intensity.

In some embodiments, the third intensity is equal in intensity with the high intensity.

In some embodiments, the at least one optical passage is an optical through-silicon via (TSV) formed through a silicon substrate.

In some embodiments, the input layer and the static layer are directly connected to one another.

In some embodiments, the at least one emitter is optically coupled to the at least one optical passage with at least one optical fiber for directing electromagnetic energy from the at least one emitter into the at least one optical passage.

In some embodiments, the input layer and the static layer are positioned separate from one another.

In some embodiments, a method for performing a collective operation using electromagnetic energy includes displaying an encoded electromagnetic signal encoded via an intensity of electromagnetic energy based on an input value; emitting the encoded electromagnetic signal through a static layer having one or more optical filters encoded via an opacity of the one or more optical filters based on a learned parameter; detecting a cumulative electromagnetic signal through the static layer, the cumulative electromagnetic signal including the intensity of electromagnetic energy of the encoded electromagnetic signal as filtered by the one or more optical filters; and determining a product of the input value and the learned parameter based on decoding the cumulative electromagnetic signal.

In some embodiments, the method further includes displaying the encoded electromagnetic signal as a pattern of one or more entries displayed at a set of one or more emitters, and emitting electromagnetic energy of a selected intensity for each entry at the set of one or more emitters through one or more optical passages in the static layer, wherein the one or more optical filters are positioned within the one or more optical passages.

In some embodiments, emitting the encoded electromagnetic signal through the static layer includes transmitting the encoded electromagnetic signal displayed at the set of one or more emitters through one or more optical fibers optically coupling the set of one or more emitters to the one or more optical passages.

In some embodiments, the method further includes detecting the intensity of a set of one or more entries of the cumulative electromagnetic signal with one or more photodetectors, wherein each entry of the cumulative electromagnetic signal has an intensity of a first intensity, a second intensity greater than the first intensity, or a third intensity greater than the second intensity.

In some embodiments, the one or more optical filters include one or more optical filters being a low optical filter having a high opacity and one or more optical filters being a high optical filter having a low opacity less than the high opacity, and the method further includes: for a first subset of entries of the set of one or more entries of the encoded electromagnetic signal, emitting electromagnetic energy through the static layer as electromagnetic energy having a low intensity; and for a second subset of entries of the set of one or more entries of the encoded electromagnetic signal, emitting electromagnetic energy through the static layer as a high intensity greater than the low intensity.

In some embodiments, the method further includes: when an entry of the encoded electromagnetic signal is displayed at the low intensity and emitted through the low optical filter, generating an entry of the cumulative electromagnetic signal having the first intensity; when an entry of the encoded electromagnetic signal is displayed at the low intensity and emitted through the high optical filter, generating an entry of the cumulative electromagnetic signal having the second intensity; when an entry of the encoded electromagnetic signal is displayed at the high intensity and emitted through the low optical filter, generating an entry of the cumulative electromagnetic signal having the second intensity; and when an entry of the encoded electromagnetic signal is displayed at the high intensity and emitted through the high optical filter, generating an entry of the cumulative electromagnetic signal having the third intensity.

In some embodiments, the method further includes receiving the input value and generating the encoded electromagnetic signal based on a logarithmic transformation of the input value, and wherein the static layer is an encoded representation of a logarithmic transformation of the learned parameter.

In some embodiments, the cumulative electromagnetic signal represents a sum value of a sum of the logarithmic transformation of the input value and the logarithmic transformation of the learned parameter, and determining the product includes exponentiating the sum value, the sum value being a logarithmic value.

In some embodiments, a method of performing a collective operation using electromagnetic energy includes: transforming a set of inputs for a set of nodes of a first layer of an artificial intelligence (AI) model into a set of logarithmic inputs for the set of nodes; encoding the set of logarithmic inputs into a set of encoded electromagnetic signals via an intensity of electromagnetic energy displaying the set of encoded electromagnetic signals at a set of emitters; emitting the set of encoded electromagnetic signals through a set of optical passages in a substrate of a static layer, the set of optical passages including a set of optical filters encoding a set of logarithmic learned parameters transformed from a set of learned parameters corresponding to the set of nodes; detecting a set of cumulative electromagnetic signals through the static layer including the intensities of electromagnetic energy for the set of encoded electromagnetic signals as filtered by the set of optical filters; decoding a set of sum values from the set of cumulative electromagnetic signals, each sum value being a sum of one logarithmic input of the set of logarithmic inputs and a corresponding logarithmic learned parameter of the set of logarithmic learned parameters; and determining a set of weighted input values based on exponentiating the set of sum values, each of the weighted input values being a product of an input of the set of inputs and a corresponding learned parameter of the set of learned parameters.

In some embodiments, the method further includes summing the set of weighted input values to generate a sum value for the set of nodes, and transmitting the sum value to one or more nodes of a second layer of the AI model.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or processing process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A device for performing collective operations using electromagnetic energy, comprising:
an input layer including at least one emitter for displaying electromagnetic signals encoded via an intensity of electromagnetic energy, wherein the at least one emitter is configured to emit electromagnetic energy at a low intensity, and to emit electromagnetic energy at a high intensity that is greater than the low intensity; and
a static layer comprising a substrate having at least one optical passage therethrough corresponding with and optically coupled to the at least one emitter and optically coupled to the input layer such that the at least one emitter emits electromagnetic energy into the at least one optical passage, wherein the at least one optical passage includes at least one optical filter and wherein the static layer is encoded via an opacity of the at least one optical filter.

2. The device of claim 1, further comprising a detecting layer including at least one photodetector corresponding with the at least one optical passage and positioned such that the at least one photodetector detects the intensity of electromagnetic energy passing through the at least one optical filter.

3. The device of claim 1, wherein the low intensity is non-zero.

4. The device of claim 1, wherein the at least one optical passage includes a plurality of optical passages each having an optical filter that is one of:
a low optical filter that has a high opacity; or
a high optical filter that has a low opacity that is less than the high opacity.

5. The device of claim 4, wherein the optical filters of the plurality of optical passages are configured such that:
electromagnetic energy at the low intensity passing through an optical passage with the low optical filter generates a cumulative electromagnetic signal having a first intensity;
electromagnetic energy at the low intensity passing through an optical passage with the high optical filter generates a cumulative electromagnetic signal having a second intensity greater than the first intensity;
electromagnetic energy at the high intensity passing through an optical passage with the low optical filter generates a cumulative electromagnetic signal having the second intensity; and
electromagnetic energy at the high intensity passing through an optical passage with the high optical filter generates a cumulative electromagnetic signal having a third intensity greater than the second intensity.

6. The device of claim 5, wherein the third intensity is equal in intensity with the high intensity.

7. The device of claim 1, wherein the at least one optical passage is an optical through-silicon via (TSV) formed through a silicon substrate.

8. The device of claim 1, wherein the input layer and the static layer are directly connected to one another.

9. The device of claim 1, wherein the at least one emitter is optically coupled to the at least one optical passage with at least one optical fiber for directing electromagnetic energy from the at least one emitter into the at least one optical passage.

10. The device of claim 9, wherein the input layer and the static layer are positioned separate from one another.

11. A method for performing a collective operation using electromagnetic energy, comprising:
displaying an encoded electromagnetic signal encoded via an intensity of electromagnetic energy based on an input value;
emitting the encoded electromagnetic signal through a static layer having one or more optical filters encoded via an opacity of the one or more optical filters based on a learned parameter;
detecting a cumulative electromagnetic signal through the static layer, the cumulative electromagnetic signal including the intensity of electromagnetic energy of the encoded electromagnetic signal as filtered by the one or more optical filters; and
determining a product of the input value and the learned parameter based on decoding the cumulative electromagnetic signal.

12. The method of claim 11, further comprising displaying the encoded electromagnetic signal as a pattern of one or more entries displayed at a set of one or more emitters, and emitting electromagnetic energy of a selected intensity for each entry at the set of one or more emitters through one or more optical passages in the static layer, wherein the one or more optical filters are positioned within the one or more optical passages.

13. The method of claim 12, wherein emitting the encoded electromagnetic signal through the static layer includes transmitting the encoded electromagnetic signal displayed at the set of one or more emitters through one or more optical fibers optically coupling the set of one or more emitters to the one or more optical passages.

14. The method of claim 11, further comprising detecting the intensity of a set of one or more entries of the cumulative electromagnetic signal with one or more photodetectors, wherein each entry of the cumulative electromagnetic signal has an intensity of a first intensity, a second intensity greater than the first intensity, or a third intensity greater than the second intensity.

15. The method of claim 14, wherein the one or more optical filters include one or more optical filters being a low optical filter having a high opacity and one or more optical filters being a high optical filter having a low opacity less than the high opacity, and further comprising:
for a first subset of entries of the set of one or more entries of the encoded electromagnetic signal, emitting electromagnetic energy through the static layer as electromagnetic energy having a low intensity; and
for a second subset of entries of the set of one or more entries of the encoded electromagnetic signal, emitting electromagnetic energy through the static layer as a high intensity greater than the low intensity.

16. The method of claim 15, further comprising:
when an entry of the encoded electromagnetic signal is displayed at the low intensity and emitted through the low optical filter, generating an entry of the cumulative electromagnetic signal having the first intensity;
when an entry of the encoded electromagnetic signal is displayed at the low intensity and emitted through the high optical filter, generating an entry of the cumulative electromagnetic signal having the second intensity;
when an entry of the encoded electromagnetic signal is displayed at the high intensity and emitted through the low optical filter, generating an entry of the cumulative electromagnetic signal having the second intensity; and
when an entry of the encoded electromagnetic signal is displayed at the high intensity and emitted through the high optical filter, generating an entry of the cumulative electromagnetic signal having the third intensity.

17. The method of claim 11, further comprising receiving the input value and generating the encoded electromagnetic signal based on a logarithmic transformation of the input value, and wherein the static layer is an encoded representation of a logarithmic transformation of the learned parameter.

18. The method of claim 17, wherein the cumulative electromagnetic signal represents a sum value of a sum of the logarithmic transformation of the input value and the logarithmic transformation of the learned parameter, and determining the product includes exponentiating the sum value, the sum value being a logarithmic value.

19. A method of performing a collective operation using electromagnetic energy, comprising:
transforming a set of inputs for a set of nodes of a first layer of an artificial intelligence (AI) model into a set of logarithmic inputs for the set of nodes;
encoding the set of logarithmic inputs into a set of encoded electromagnetic signals via an intensity of electromagnetic energy;
displaying the set of encoded electromagnetic signals at a set of emitters;
emitting the set of encoded electromagnetic signals through a set of optical passages in a substrate of a static layer, the set of optical passages including a set of optical filters encoding a set of logarithmic learned parameters transformed from a set of learned parameters corresponding to the set of nodes;
detecting a set of cumulative electromagnetic signals through the static layer including the intensities of electromagnetic energy for the set of encoded electromagnetic signals as filtered by the set of optical filters;
decoding a set of sum values from the set of cumulative electromagnetic signals, each sum value being a sum of one logarithmic input of the set of logarithmic inputs and a corresponding logarithmic learned parameter of the set of logarithmic learned parameters; and
determining a set of weighted input values based on exponentiating the set of sum values, each of the weighted input values being a product of an input of the set of inputs and a corresponding learned parameter of the set of learned parameters.

20. The method of claim 19, further comprising summing the set of weighted input values to generate a sum value for the set of nodes, and transmitting the sum value to one or more nodes of a second layer of the AI model.
